(19) United States
(12) Patent Application Publication
(10) Pub. No.: US 2007/0011361 A1
(43) Pub. Date: Jan. 11, 2007

(54) Storage management system

(76) Inventors: Wataru Okada, Odawara (JP); Yuri Hiraiwa, Sagamihara (JP); Masahide Sato, Noda (JP); Naoko Ikegaya, Sagamihara (JP); Nobuo Ihara, Yokohama (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/225,134

(22) Filed: Sep. 14, 2005

(30) Foreign Application Priority Data
Jul. 7, 2005 (JP) 2005-198804

(51) Int. Cl. G06F 3/00

(52) U.S. Cl. 710/8

(57) ABSTRACT

Conventionally, it has been impossible to choose storage subsystems for selective implementation of I/O delay to prevent buffer from overflowing during remote copy. According to this invention, in a management computer that manages serially connected plural storage subsystems in a computer system, the computer system having a host computer to write data in the storage subsystems, the plural storage subsystems each have one or more logical volumes where data is stored and a buffer where data is stored temporarily, the logical volume of one of the storage subsystems and the logical volume of another of the storage subsystems form a pair for remote copy, and the management computer observes the usage of each buffer and issues, when the usage of the buffer exceeds a given threshold in a first storage subsystem, a command to delay executing write processing to the storage subsystems that are upstream of the first storage subsystem.

### CROSS-REFERENCE TO PRIOR APPLICATION

This application relates to and claims priority from Japanese Patent Application No. 2005-198804 filed on Jul. 7, 2005 the entire disclosure of which is incorporated herein by reference.

### BACKGROUND

This invention relates to a storage system control technique, and more specifically to a technique of controlling data transfer in storage systems by utilizing remote copy technology.

Today the use of an information system is a given in many business activities and the like. A prolonged shutdown of an information system due to unforeseen events, such as natural disasters, accidents, and terrorist attacks, can therefore cause serious damage. To minimize the damage, a disaster recovery technique as an application of remote copy technology has been proposed. With this technique, an information system can quickly recover from a failure by using a copy of business data which has been created on a remote site (remote copy) while the system works normally.

According to remote copy technology, data written in a logical volume (LU) of a direct-coupled storage subsystem, a storage subsystem that is directly connected to a host computer, is copied to a LU of a remotely located storage subsystem (remote storage subsystem). A pair of such LUs between which data is copied is called a copy pair. To maintain the data consistency between the original and a copy, the I/O order is ensured. The I/O order is ensured by writing data in the LU of the remote storage subsystem in the same order in which the data is written in the LU of the direct-coupled storage subsystem from the host computer. If copying of data that should be written first is performed after copying of data that should be written nest because the original I/O order is disrupted somehow, and if a failure occurs before this data is actually written, the data consistency is lost in the LU of the remote storage subsystem. A system cannot be recovered with data that has lost consistency.

In some cases, data consistency has to be maintained among plural copy pairs. Such copy pairs are called a consistency group (CG). An I/O order is ensured in each CG.

To ensure the I/O order and thereby maintain data consistency, a variation of remote copy technology has been proposed that uses a cache called a side file (see JP 2002-334049 A). According to JP 2002-334049 A, data to be copied from a direct-coupled storage subsystem (master disk subsystem) to a remote storage subsystem (remote disk subsystem) is sent to the remote storage subsystem after stored in a primary cache (a cache memory of the master disk subsystem) of the direct-coupled storage subsystem. Receiving the data, the remote storage subsystem first stores the data in a secondary cache (a cache memory of the remote disk subsystem). Then the data in the secondary cache is written in a volume of the remote storage subsystem in an order in which the data has been written in the direct-coupled storage subsystem.

The data in the primary cache is held until the direct-coupled storage subsystem is informed that the downstream remote storage subsystem has finished storing a copy of the data in the secondary cache. Since the capacity of the primary cache is limited, the primary cache could be overflown with data when the two storage subsystems communicate at a low communication rate. In this case, the data consistency cannot be maintained. According to JP 2002-334049 A, the direct-coupled storage subsystem monitors how much of the primary cache is in use and, when the usage exceeds a given threshold, controls (delays) I/O from the host computer. Specifically, the direct-coupled storage subsystem intentionally delays responding to a write command from the host computer, to thereby lower the rate of storing data in the primary cache, which avoids an overflow of the primary cache. As a result, the data consistency is maintained without bringing the system to a halt.

Another variation of remote copy technology has been proposed in which the same data is copied to more than one remote storage subsystem to further fortify an information system against failures (see, for example, JP 2003-122509 A). According to JP 2003-122509 A, data in a direct-coupled storage subsystem is copied to two remote storage subsystems. If a failure occurs in one of the three storage subsystems, the data is recovered through remote copy executed between the remaining two storage subsystems. The information system is thus made highly withstanding against failures.

### SUMMARY

One form of connecting storage subsystem for such remote copy that copies data to plural remote storage subsystems is a cascade type. The cascade type is a serial connection form in which a first remote storage subsystem is connected to a direct-coupled storage subsystem and a second remote storage subsystem is connected to the first remote storage subsystem. Data written in the direct-coupled storage subsystem is copied to the first remote storage subsystem and then to the second remote storage subsystem. In the similar fashion, third and fourth remote storage subsystems may be connected in series downstream of the second remote storage subsystem. The invention disclosed in JP 2002-334049 A is also applicable to such cascade type connection forms.

However, according to the invention of JP 2002-334049 A, each time the usage of a cache in any one of the storage subsystems exceeds a given threshold, I/O delay is implemented in the storage subsystem that has the cache. The I/O delay lowers the rate of writing data in this storage subsystem. If a cache of a storage subsystem that is upstream of the I/O-controlled storage subsystem is close to the threshold itself, the upstream cache is very likely overflown with data.

For instance, in the case where a lot of tasks are happen to be processed at once in one of CGs, causing the usage of a primary cache in this CG to exceed the threshold, I/O delay is implemented in a storage subsystem to which the primary cache belongs. Then a cache of a storage subsystem that is upstream of the storage subsystem to which the primary cache belongs is likely to overflow. If the cache of the upstream storage subsystem overflows, remote copy is suspended not only in the CG where the processing traffic is busy but also in a CG that is in a different sequence. Thus, the invention disclosed in JP 2002-334049 A lets an overflow of a cache in one CG to affect a CG in a different sequence.

Other than temporary processing traffic jams, a link failure between storage subsystems can also cause the usage of a cache to exceed its threshold. For instance, in the case where all links between two storage subsystems fail, a cache in the upstream one of the two storage subsystems will be overflown with data. An overflow in such circumstances cannot be avoided by I/O delay since it merely slows down I/O instead of completely cutting off I/O. In short, I/O delay in such circumstances lowers the I/O rate to no avail. Moreover, as in the aforementioned case, a failure in one CG could affect another CG.

According to an embodiment of this invention, there is provided a management computer that manages plural storage subsystems in a computer system, the computer system having a host computer that writes data in at least one of the plural storage subsystems, wherein the plural storage subsystems constitute at least one sequence that is composed of at least three storage subsystems connected in series, wherein the host computer is connected to the most upstream storage subsystem of the sequence, wherein the plural storage subsystems each have: one or more logical volumes where data is stored; and a buffer where data is stored temporarily, wherein the logical volume of one of the storage subsystems and the logical volume of another of the storage subsystems form a pair for remote copy, wherein the buffer stores at least one of data to be stored in the logical volume from the host computer, data to be stored in the logical volume through the remote copy from another storage subsystem, and data to be sent through the remote copy to another storage subsystem, and wherein the management computer includes an information collecting module, which observes a usage of the buffer in each of the plural storage subsystems, and which issues, when the usage of the buffer exceeds a given threshold in a first storage subsystem, a delay command to delay executing write processing to a second storage subsystem that is upstream of the first storage subsystem.

According to an embodiment of this invention, when the usage of a cache exceeds its threshold, I/O delay can be implemented in other storage subsystems than the one to which the overflown cache belongs. Therefore, it is possible to select one or more storage subsystems and to implement the I/O delay in the storage subsystems, which allows the use of the cache having the sufficient area left unused. As a result, an overflow in another storage subsystem can be avoided and I/O delay is carried through without affecting processing in other CGs.

Furthermore, this embodiment has the operation state of a link between storage subsystems observed so that I/O delay is implemented only when executing I/O delay does not cause another overflow. In other words, this embodiment does not permit I/O delay that is unavailing, thus avoiding wasting resources and lowering the host I/O performance.

### BRIEF DESCRIPTION OF THE DRAWINGS

FIG. 1 is a block diagram showing a configuration of a computer system according to a first embodiment of this invention.

FIG. 2 is a block diagram showing a configuration of a management computer according to the first embodiment of this invention.

FIG. 3 is a block diagram showing a configuration of a direct-coupled storage subsystem according to the first embodiment of this invention.

FIG. 4 is a block diagram showing a configuration of a remote storage subsystem according to the first embodiment of this invention.

FIG. 5 is a block diagram showing a configuration of another remote storage subsystem according to the first embodiment of this invention.

FIG. 6A is an explanatory diagram of a monitoring setting screen displayed on the management computer in order to set the monitoring settings information according to the first embodiment of this invention.

FIG. 6B is an explanatory diagram of the monitoring settings information set on the monitoring setting screen according to the first embodiment of this invention.

FIG. 7 is a flow chart of a configuration information collecting program in the management computer according to the first embodiment of this invention.

FIG. 8 is an explanatory diagram of a copy pair management information stored in the management computer according to the first embodiment of this embodiment.

FIG. 9 is a flow chart of a threshold setting program in the management computer according to the first embodiment of this invention.

FIG. 10 is an explanatory diagram of a threshold setting screen displayed on the management computer according to the first embodiment of this invention.

FIG. 11A is an explanatory diagram of the total cache usage threshold information stored in the management computer according to the first embodiment of this invention.

FIG. 11B is an explanatory diagram of the individual cache usage threshold information stored in the management computer according to the first embodiment of this invention.

FIG. 12 is an explanatory diagram of a failure definition information setting screen displayed on the management computer according to the first embodiment of this invention.

FIG. 13 is an explanatory diagram of failure definition information stored in the management computer according to the first embodiment of this invention.

FIG. 14 is an explanatory diagram of an example of a rule applied in the first embodiment of this invention.

FIG. 15 is an explanatory diagram of an I/O-controlled device information stored in the management computer according to the first embodiment of this invention.

FIG. 16 is a flow chart of an information collecting program in the management computer according to the first embodiment of this invention.

FIG. 17 is a flow chart of I/O delay device selecting processing executed by the information collecting program of the management computer according to the first embodiment of this invention.

FIG. 18A is an explanatory diagram showing the format of an I/O delay command issued to a storage subsystem by the management computer according to the first embodiment of this invention.

FIG. 18B is an explanatory diagram showing an example of an I/O delay command issued to a storage subsystem by the management computer according to the first embodiment of this invention.

FIG. 19 is a flow chart of an I/O delay command receiving program of a storage subsystem according to the first embodiment of this invention.

FIG. 20 is an explanatory diagram of I/O delay information stored in a storage subsystem according to the first embodiment of this invention.

FIG. 21 is a flow chart of an I/O delay processing program of a storage subsystem according to the first embodiment of this invention.

FIG. 22A is an explanatory diagram of the copy pair configuration information stored in a storage subsystem according to the first embodiment of this invention.

FIG. 22B is an explanatory diagram of the cache management table stored in a storage subsystem according to the first embodiment of this invention.

FIG. 22C is an explanatory diagram of the link operation state table stored in a storage subsystem according to the first embodiment of this invention.

FIG. 23 is a flow chart of casing information providing processing executed by a casing information management program in a storage subsystem according to the first embodiment of this invention.

FIG. 24 is a block diagram of a host computer which implements I/O delay according to the first embodiment of this invention.

FIG. 25 is a flow chart of an I/O delay processing program of the host computer according to the first embodiment of this invention.

FIG. 26 is an explanatory diagram of consistency groups that stretch over plural storage subsystem sequences and copy pairs formed in a computer system according to the first embodiment of this invention.

FIG. 27 is an explanatory diagram showing what a copy pair management information stored in the management computer when one consistency group stretches over plural storage subsystem sequences in the first embodiment of this invention.

FIG. 28 is an explanatory diagram of monitoring settings information stored in the management computer according to the second embodiment of this invention.

FIG. 29A is an explanatory diagram showing the format of a state information obtaining command issued to a direct-coupled storage subsystem by the management computer according to the second embodiment of this invention.

FIG. 29B is an explanatory diagram showing an example of a state information obtaining command issued to a direct-coupled storage subsystem by the management computer according to the second embodiment of this invention.

FIG. 30 is a flow chart of sequence state obtaining processing executed by a casing information management program in a storage subsystem according to the second embodiment of this invention.

FIG. 31A is an explanatory diagram showing the format of an I/O delay command issued to a storage subsystem by the management computer according to the second embodiment of this invention.

FIG. 31B is an explanatory diagram showing an example of an I/O delay command issued to a storage subsystem by the management computer according to the second embodiment of this invention.

FIG. 32 is a flow chart of an I/O delay command receiving program of a storage subsystem according to the second embodiment of this invention.

### DETAILED DESCRIPTION OF THE PREFERRED EMBODIMENTS

Embodiments of this invention will be described below with reference to the accompanying drawings. Described first is a first embodiment of this invention.

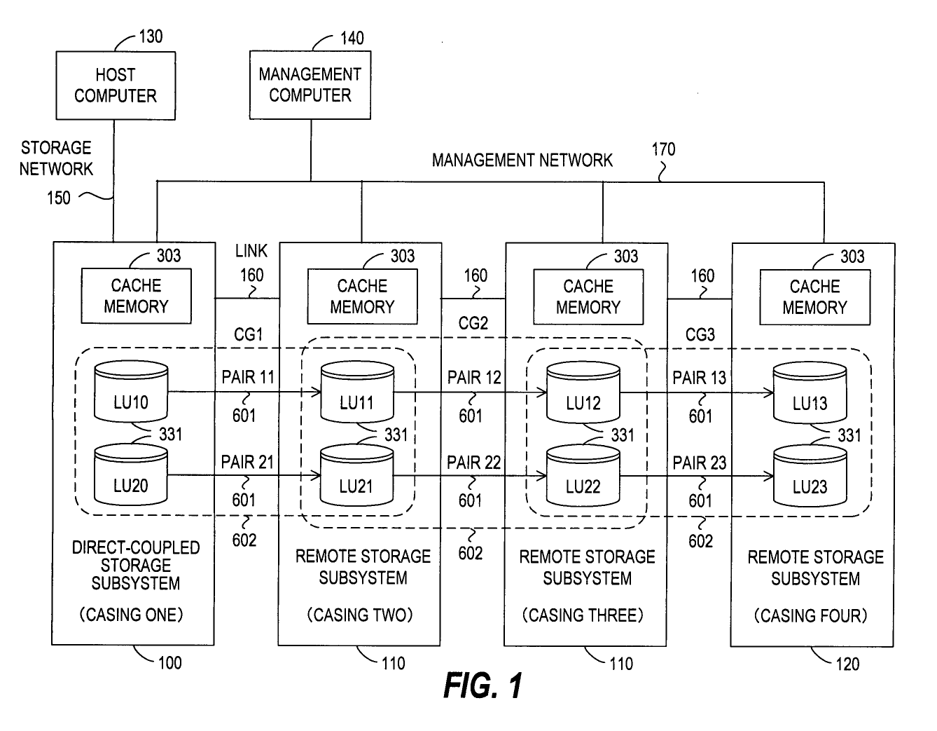

FIG. 1 is a block diagram showing the configuration of a computer system according to the first embodiment of this invention.

The computer system of this embodiment comprises four storage subsystems, a host computer 130 and a management computer 140.

The four storage subsystems are connected in series via links 160. One of the four storage subsystems, a direct-coupled storage subsystem 100, is connected to the host computer 130 via a storage network 150. The remaining three are remote storage subsystems denoted by 110 or 120. In the following description, the expression “storage subsystem” will be used when there is no particular need to distinguish the direct-coupled storage subsystem 100 and the remote storage subsystems 110 and 120 from one another.

The configurations of a cache memory 303, logical volumes (LUs) 331 and others in each storage subsystem will be described later in detail. Similarly, copy pairs 601 constituted of the LUs 331 and consistency groups (CGs) 602 will be described later in detail.

The links 160 are communication paths between storage subsystems. One or more links 160 connect any two storage subsystems with each other. The links 160 may be, for example, Fibre Channel (FC), or may partially utilize public telephone networks and the like in the case where storage subsystems the links 160 connect are far apart from each other. Remote copy that will be described later is executed via the links 160.

In the following description, of the storage subsystems connected in series, ones that are close to the host computer 130 will be referred to as “upstream” storage subsystems whereas ones that are far from the host computer 130 will be referred to as “downstream” storage subsystems. In this embodiment, no storage subsystem is upstream of the direct-coupled storage subsystem 100, two remote storage subsystems 110 are connected downstream of the direct-coupled storage subsystem 100, and the remote storage subsystem 120 is connected downstream of the remote storage subsystems 110.

In other words, the direct-coupled storage subsystem 100 is located at the end of upstream side of the serially connected storage subsystems.

Data written in logical volumes (will be described later) of the direct-coupled storage subsystem 100 from the host computer 130 is copied to logical volumes of the downstream remote storage subsystems 110 and 120 in order (remote copy). A configuration in which plural storage subsystems are connected in series to sequentially copy data from upstream to downstream as this is sometimes called a cascade configuration.

In the following description, one direct-coupled storage subsystem 100 and its downstream remote storage subsystems 110 and 120 will collectively be called as a “sequence”.

A pair of two logical volumes between which data is copied will be called as a “copy pair”.

There are two types of remote copy, synchronous remote copy and asynchronous remote copy.

The description in this embodiment takes as an example asynchronous remote copy. The computer system of this embodiment may employ synchronous copy and asynchronous copy simultaneously.

In this embodiment, one sequence is constituted of four storage subsystems. This invention is also applicable to a computer system that has more than four storage subsystems.

Although FIG. 1 shows only one sequence, this invention is also applicable to a computer system in which plural sequences are connected to one host computer 130.

Each storage subsystem is given a unique storage subsystem identifier (ID) made up of a string of numbers or characters. This embodiment uses “Casing One”, “Casing Two”, “Casing Three” and “Casing Four” for the four storage subsystems from upstream down. “Casing One” is the storage subsystem ID of the direct-coupled storage subsystem 100, and “Casing Two” is the storage subsystem ID of the remote storage subsystems 110. “Casing Three” is the storage subsystem ID of the downstream one of the remote storage subsystems 110. “Casing Four” is the storage subsystem ID of the remote storage subsystem 120 which is downstream of the remote storage subsystems 110. Hereinafter, the storage subsystem that has a storage subsystem ID “Casing One” (the direct-coupled storage subsystem 100 in this embodiment) is simply referred to as Casing One. The same principle applies to other storage subsystems.

The host computer 130 is a computer that is connected to the direct-coupled storage subsystem 100 via the storage network 150 and executes data write/read in the direct-coupled storage subsystem 100. While details of the configuration of the host computer 130 will not be described, the host computer 130 has a CPU, a memory and others (not shown).

The storage network 150 is a network over which the host computer 130 and the direct-coupled storage subsystem 100 communicate with each other. Communications carried over the storage network 150 use such protocols as FC and SCSI. The storage network 150 used may be, for example, a storage area network (SAN).

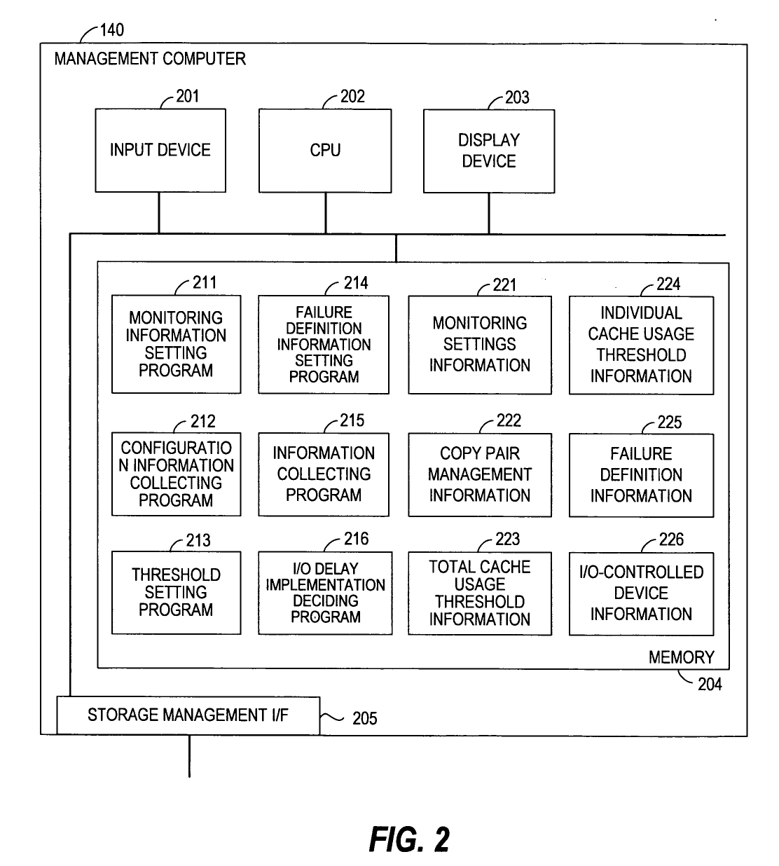

The management computer 140 is connected to each of the storage subsystems via a management network 170 to manage the storage subsystems. The configuration of the management computer 140 will be described later in detail with reference to FIG. 2.

The management network 170 is a network over which the management computer 140 and each storage subsystem communicate with each other. The management network 170 in this embodiment is an IP network. Accordingly, the management computer 140 identifies the storage subsystems by their IP addresses. However, this embodiment may employ other networks than an IP network for the management computer 140.

FIG. 2 is a block diagram showing the configuration of the management computer 140 according to the first embodiment of this invention.

The management computer 140 of this embodiment comprises, at least, an input device 201, a CPU 202, a display device 203, a memory 204 and a storage management interface (I/F) 205.

The input device 201 is a device used by a system administrator to set various parameters and the like of the computer system. For example, a keyboard or a pointing device can serve as the input device 201.

The CPU 202 is a processor that executes various programs stored in the memory 204.

The display device 203 is a device on which the state of the computer system, various messages, and the like are displayed. An image display device such as a CRT can serve as the display device 203. The display device 203 may provide a graphical user interface (GUI) when the system administrator sets various parameters of the computer system.

The memory 204 is, for example, a semiconductor memory. The memory 204 stores various programs executed by the CPU 202, and diverse information referred to upon execution of the programs. The memory 204 of this embodiment stores, at least, a monitoring information setting program 211, a configuration information collecting program 212, a threshold setting program 213, a failure definition information setting program 214, an information collecting program 215, an I/O delay implementation deciding program 216, monitoring settings information 221, copy pair management information 222, total cache usage threshold information 223, individual cache usage threshold information 224, failure definition information 225 and I/O-controlled device information 226. These programs and information will be described later in detail.

The storage management I/F 205 is an interface connected to each of the storage subsystems via the management network 170 to communicate with the storage subsystems.

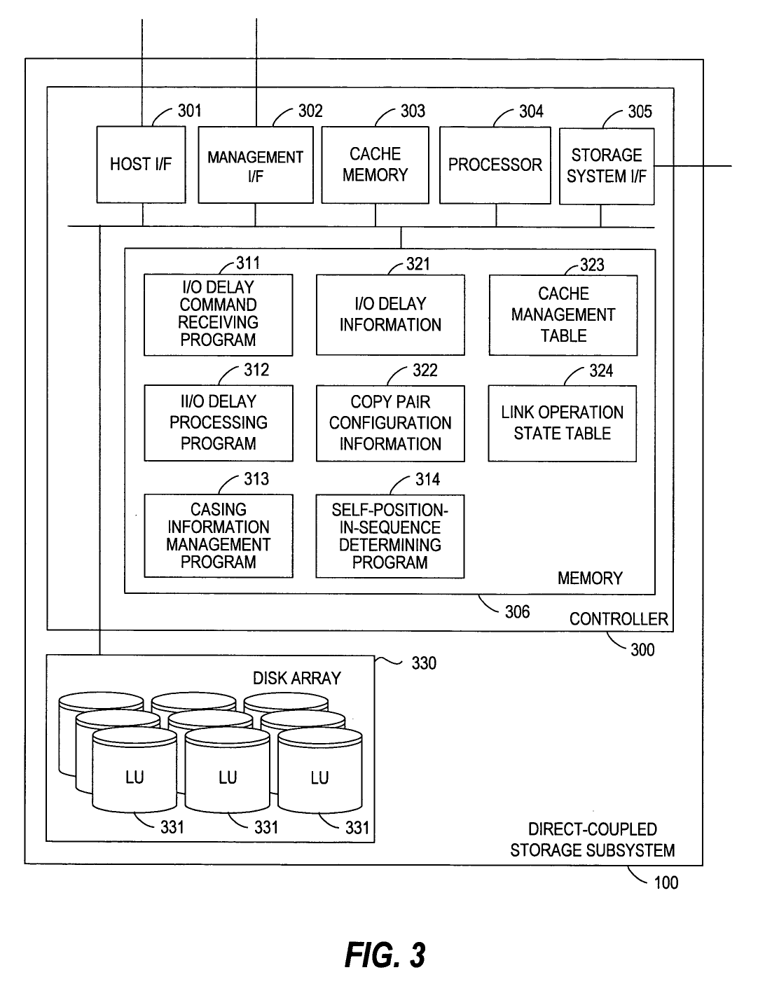

FIG. 3 is a block diagram showing the configuration of the direct-coupled storage subsystem 100 according to the first embodiment of this invention.

The direct-coupled storage subsystem 100 of this embodiment comprises a controller 300 and a disk array 330.

The controller 300 is a device to control the direct-coupled storage subsystem 100, and comprises, at least, a host I/F 301, a management I/F 302, a cache memory 303, a processor 304, a storage system I/F 305 and a memory 306.

The host I/F 301 is an interface connected to the host computer 130 via the storage network 150 to communicate with the host computer 130.

The management I/F 302 is an interface connected to the management computer 140 via the management network 170 to communicate with the management computer 140.

The cache memory 303 is a memory to store data temporarily. For instance, the cache memory 303 may temporarily store data that is to be copied when asynchronous remote copy is executed. Details will be given later on this and other uses of the cache memory 303. The cache memory 303 may also temporarily store data to be written in the disk array 330 or data read out of the disk array 330.

The processor 304 executes various programs stored in the memory 306.

The storage system I/F 305 is connected to the remote storage subsystems 110 and 120 via the links 160. Data copied through remote copy is sent and received by the storage I/F 305.

The memory 306 is, for example, a semiconductor memory. The memory 306 stores various programs executed by the processor 304, and diverse information referred to upon execution of the programs. The memory 306 of this embodiment stores, at least, an I/O delay command receiving program 311, an I/O delay processing program 312, a casing information management program 313, I/O delay information 321, copy pair configuration information 322, a cache management table 323 and a link operation state table 324. These programs and information will be described later in detail.

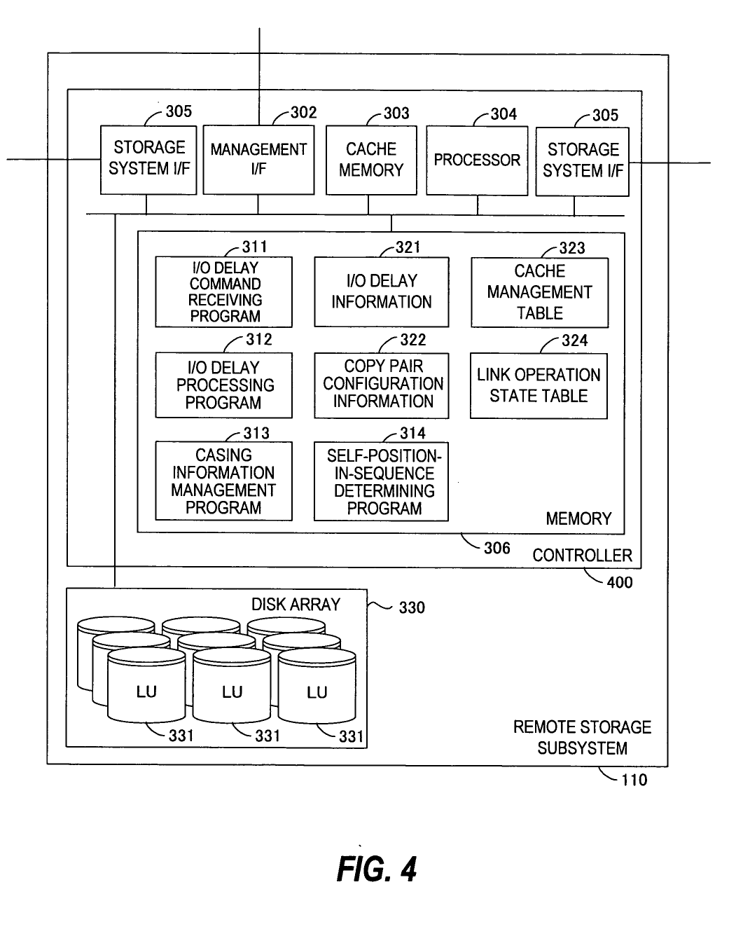

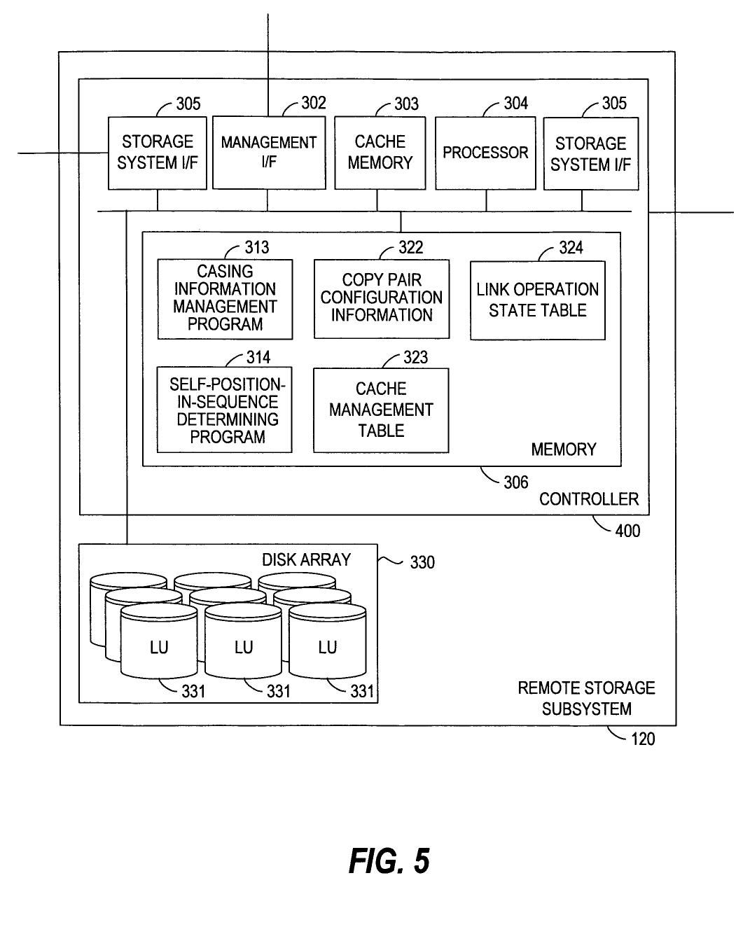

The memory 306 in FIG. 3 stores a self-position-in-sequence determining program 314, which is not needed by the direct-coupled storage subsystem 100 of this embodiment. It is a second embodiment described later where the self-position-in-sequence determining program 314 is needed. The same applies to the remote storage subsystems 110 and 120 shown in FIGS. 4 and 5.

The disk array 330 is storage made up of plural disk drives (not shown). The disk array 330 may constitute Redundant Arrays of Inexpensive Disks (RAID), for example.

Data is stored in the disk array 330 upon receiving a write request from the host computer 130. Data stored in the disk array 330 is read as a read request is received from the host computer 130.

The storage area (area where data is stored) of the disk array 330 is managed as one or more logical volumes (LUs) 331. The LUs 331 are areas recognized as logical disk drives by the host computer.

FIG. 4 is a block diagram showing the configuration of the remote storage subsystems 110 according to the first embodiment of this invention.

The remote storage subsystems 110 partially have the same configuration as the direct-coupled storage subsystem 100, and a description on that part will be omitted.

Each of the remote storage subsystems 110 of this embodiment comprises a controller 400 and a disk array 330.

The controller 400 is a device to control the respective remote storage subsystems 110. The controller 400 comprises, at least, a management I/F 302, a cache memory 303, a processor 304 and two storage system I/Fs 305 and a memory 306.

One of the two storage systems I/Fs 305 is connected to an upstream storage subsystem whereas the other is connected to a downstream storage subsystem.

FIG. 5 is a block diagram showing the configuration of the remote storage subsystems 120 according to the first embodiment of this invention.

The remote storage subsystem 120 of this embodiment has the same configuration as the remote storage subsystems 110. The difference between the remote storage subsystems 110 and 120 is that a memory 306 of the remote storage subsystem 120 stores a casing information management program 313, copy pair configuration information 322, a cache management table 323 and a link operation state table 324 but not an I/O delay command receiving program 311, an I/O delay processing program 312 and I/O delay information 321.

Described next with reference to FIG. 1 are consistency groups and copy pairs formed in the computer system of this embodiment.

A copy pair 601 refers to a pair of the LUs 331 between which remote copy is executed. Specifically, one of the LUs 331 from which data is copied (copy source) and another of the LUs 331 to which the data is copied (copy destination) make one copy pair 601. In FIG. 1, LUs forming one copy pair 601 is indicated by an arrow.

In this embodiment, the LUs 331 are identified by their respective LU identifiers (LU IDs). In the following description, one of the LUs 331 that has an LU identifier “LU10” will simply be referred to as LU10. The same principle applies to other LU identifiers.

As shown in FIG. 1, Casing One of this embodiment stores at least two LUs 331, LU10 and LU20. Casing Two stores at least two LUs 331, LU11 and LU21. Casing Three stores at least two LUs 331, LU12 and LU22. Casing Four stores at least two LUs 331, LU13 and LU23.

As shown in FIG. 1, LU10 and LU11 form one copy pair 601. The copy pair 601 has a pair identifier (pair ID) “Pair11”. In the following description, the copy pair 601 that has the pair ID “Pair11” will simply be referred to as “Pair11”. The same principle applies to other pairs 601.

As shown in FIG. 1, LU11 and LU12 form Pair12. LU12 and LU13 form Pair13. LU20 and LU21 form Pair21. LU21 and LU22 form Pair22. LU22 and LU23 form Pair23.

In one copy pair 601, one of the two LUs 331 from which data is copied (i.e. the LU of copy source) is referred to as “primary LU” and the other of the two LUs 331 to which the data is copied (i.e. the LU of copy destination) is referred to as “secondary LU”. The point of an arrow in FIG. 1 indicates a secondary LU and the proximal end of the arrow indicates the primary LU paired with the secondary LU. For example, LU10 serves as the primary LU of Pair11 and LU11 serves as the secondary LU of Pair11. While being the secondary LU of Pair11, LU11 is also the primary LU of Pair12.

LU10, LU11, LU12 and LU13 linked by copy pairs 601 constitute one sequence. Similarly, LU20, LU21, LU22 and LU23 linked by copy pairs 601 constitute another sequence.

When a sequence of copy pairs 601 as the one shown in FIG. 1 is formed, data written in LU10 of Casing One from the host computer 130 is copied (remote copy) from LU10 to LU11, from LU11 to LU12, and then from LU12 to LU13 to be stored in each of the four LUs 331. Similarly, data written in LU20 of Casing One from the host computer 130 is copied to and stored in LU21, LU22, and LU23 in the order stated.

There are two types of remote copy, synchronous remote copy and asynchronous remote copy.

For example, Casing One receives from the host computer 130 a data write request to write data in LU10, stores the data in LU10, and then copies the data to LU11 of Casing Two (remote copy). Specifically, Casing One transfers the data to Casing Two via the links 160. Casing Two stores, in LU11, the data received from Casing One, and notifies Casing One of completion of the write request.

In the case where synchronous remote copy is employed in this example, Casing One stores the data in LU10 and, after receiving the notification from Casing Two, notifies the host computer 130 of completion of writing the data.

In the case where asynchronous remote copy is employed in this example, on the other hand, Casing One stores the data in LU10, then stores the data in the cache memory 303 of Casing One and, when the cache memory 303 of Casing One finishes storing the data, notifies the host computer 130 of completion of the write request. Thereafter, the data stored in the cache memory 303 is transferred via the links 160 to Casing Two. Casing One may choose, for example, a time of day when the traffic on the links 160 is not heavy to transfer the data stored in the cache memory 303.

The data stored in the cache memory 303 of Casing One is transferred to Casing Two in the order in which the data is stored in the cache memory 303 (in other words, in the order in which the data is stored in LU10). However, Casing Two does not always receive the data in the order in which the data is transferred from Casing One. This is because data is distributed for transfer among the plural links 160 set up between Casing One and Casing Two, and sometimes data that has been sent later arrives at Casing Two quicker than data that has been sent earlier.

For instance, Data A, Data B and Data C (not shown) sent from the host computer 130 are written in LU10 in the order stated. Then Data A, Data B and Data C are transferred from Casing One to Casing Two. Casing Two receives and stores, in LU11, Data A and Data C in this order. Now, if a failure occurs in Casing One or the links 160 before Casing Two receives Data B, remote copy is suspended and LU11, where Data A and Data C are stored, fails to store Data B.

In the case where data is stored earlier or later than it should be according to the original order as this, the data consistency is lost in LU11. Data that has lost the consistency is useless. For that reason, the order of data stored in upstream one of the LUs 331 has to be kept in a downstream one of the LUs 331.

Therefore, Casing Two first stores in its cache memory 303 the data received from Casing One. Casing Two keeps Data C in its cache memory 303 without storing it in LU11 until Data B is received and stored in LU11. An area of the cache memory 303 where data to be sent through remote copy is stored once, or where received data is first stored as this, is sometimes called a side file. Hereinafter, an area where data to be sent through remote copy is stored will be referred to as primary cache whereas an area where received data is stored first will be referred to as secondary cache.

A primary cache and a secondary cache are resources used as a buffer of data to be sent and a buffer of data received, respectively. Other than the aforementioned side file, a so-called journal can serve as a primary cache or a secondary cache.

To give a specific example, when Casing Two receives Data A, Data A is stored in the cache memory 303 of Casing Two. The area where Data A is stored at this point (an area “a” (not shown)) is identified as a secondary cache. Data A is then stored in, for example, LU11. After stored in LU11, Data A is not deleted from the area “a” until Data A is transferred through remote copy to Casing Three and stored in the cache memory 303 of Casing Three. When Data A is transferred through remote copy to Casing Three, the area “a” is identified as a primary cache.

In some cases, data consistency is required to be kept among plural LUs 331. For instance, in the case where data about one database is stored in plural LUs 331, the plural LUs 331 have to keep the data consistency. Copy pairs 601 formed from LUs 331 among which data consistency has to be kept as this constitute a consistency group (CG) 602. In FIG. 1, Pair11 and Pair12 make one CG 602 (a portion encircled by a dotted line in FIG. 1).

Each CG 602 is identified by a CG identifier (CG ID). The CG 602 that is constituted of Pair11 and Pair21 has a CG ID “CG1”. Hereinafter, the CG 602 that has the CG ID “CG1” will simply be referred to as CG1. The same principle applies to other CGs 602.

Similarly, Pair12 and Pair22 constitute CG2, and Pair13 and Pair23 constitute CG3.

Each cache memory 303 contains a primary cache and/or a secondary cache for CGs 602. Specifically, the cache memory 303 of Casing One contains the primary cache of CG1. The cache memory 303 of Casing Two contains the secondary cache of CG1 and the primary cache of CG2. The cache memory 303 of Casing Three contains the secondary cache of CG2 and the primary cache of CG3. The cache memory 303 of Casing Four contains the secondary cache of CG3.

Generally speaking, a copy pair that employs synchronous remote copy and a copy pair that employs asynchronous remote copy can coexist in one computer system. However, synchronous remote copy and asynchronous remote copy cannot be mixed in one CG 602. For instance, Pair12 and Pair22, which belong to CG2 in FIG. 1, can employ synchronous remote copy while asynchronous remote copy is employed by Pair13 and Pair23, which belong to CG3. On the other hand, Pair12 cannot employ synchronous remote copy when Pair22 employs asynchronous remote copy.

This embodiment describes a case in which every copy pair 601 employs asynchronous remote copy. It should be reminded that this invention is also applicable to a computer system where a copy pair 601 that employs synchronous remote copy and a copy pair 601 that employs asynchronous remote copy are mixed.

Now, the outline of this embodiment will be given with reference to FIG. 1.

In the case where the communication traffic on the links 160 between Casing Three and Casing Four is heavy, for instance, the data transfer rate is lowered in remote copy from Casing Three to Casing Four. If the rate of data transfer from Casing Two to Casing Three is higher than the rate of data transfer from Casing Three to Casing Four, a cache storing data to be sent takes up an increasingly large portion of the cache memory 303 of Casing Three. Since the capacity of the cache memory 303 is limited, the cache memory 303 of Casing Three is eventually overflown with data. As a result, Casing Three can no longer accept data transferred from Casing Two and remote copy between Casing Two and Casing Three is suspended.

In order to avoid such suspension of remote copy, the management computer 140 of this embodiment observes the usage of the cache memory in each casing. When it is found through the observation that the amount of data stored in any cache memory has exceeded a given threshold, data I/O of one of the casings through remote copy, or data I/O from the host computer 130, is delayed to thereby prevent the cache memory from overflowing.

Before implementing I/O delay, the management computer 140 studies a failure that has occurred to judge whether or not an overflow can be avoided by delaying data I/O. For example, in the case where a failure occurs in every one of the links 160 between Casing Three and Casing Four, delaying data I/O cannot stop the cache memory 303 of Casing Three from overflowing.

The management computer 140 also observes the usage of the cache memory 303 in each casing in order to find the cache memory 303 that has room to store more data. For instance, when the cache memory 303 of Casing Three is about to overflow and the usage of the cache memory 303 of Casing Two is also close to its threshold but the cache memory 303 of Casing One still has room, the management computer 140 delays I/O between Casing One and Casing Two and between Casing Two and Casing Three, to thereby prevent the cache memory 303 of Casing Three from overflowing.

Delaying I/O from Casing One to Casing Two alone is not enough since, in some cases, data already stored in the cache memory 303 of Casing Two flows into Casing Three and causes the cache memory 303 of Casing Three to overflow unless I/O from Casing Two to Casing Three is delayed. It is therefore necessary to implement I/O delay not only between Casing One and Casing Two but also between Casing Two and Casing Three.

Details of this embodiment will be described below. The following description is about the computer system shown in FIGS. 1 to 5 unless otherwise stated.

Described first are programs and information that are stored in the management computer 140 of this embodiment.

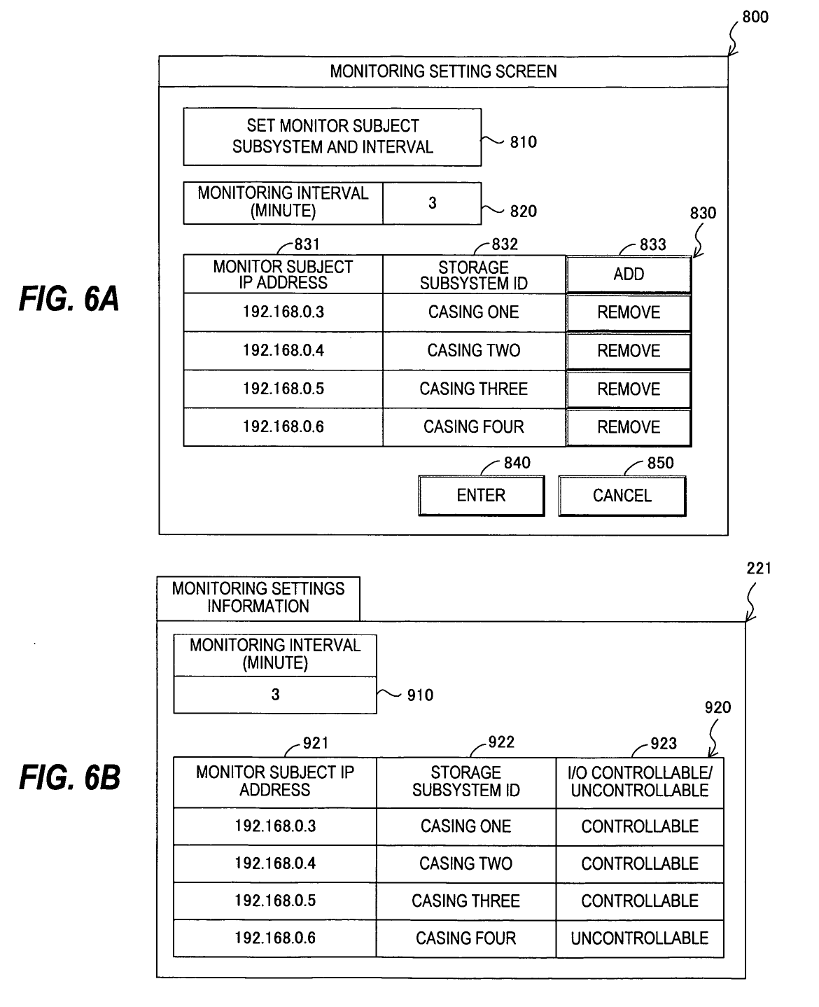

FIG. 6A is an explanatory diagram of a monitoring setting screen displayed on the management computer 140 in order to set the monitoring settings information 221 according to the first embodiment of this invention.

A monitoring setting screen 800 of FIG. 6A is displayed by the monitoring information setting program 211 on the display device 203 of the management computer 140. The monitoring setting screen 800 provides a GUI with which the system administrator sets the monitoring settings information 221.

The monitoring setting screen 800 is composed of a comment displaying field 810, a monitoring interval inputting field 820, a monitor subject inputting field 830, an enter button 840 and a cancel button 850.

The comment displaying field 810 is where a comment is displayed to prompt the system administrator to set which storage subsystem is to be monitored and a monitoring interval.

The monitoring interval inputting field 820 is where the system administrator designates a monitoring interval. A value inputted in the monitoring interval inputting field 820 by the system administrator is set as a monitoring interval, namely, an interval at which the usage of the cache memory 303 is monitored. In the example of FIG. 6A, the system administrator sets “three minutes” as the monitoring interval.

The monitor subject inputting field 830 is where the system administrator designates a storage subsystem to be monitored by the management computer 140. The usage of the cache memory of a storage subsystem that is set as a monitor subject in this field is monitored at the set monitoring interval.

The monitor subject inputting field 830 is composed of a monitor subject IP address inputting field 831, a storage subsystem ID inputting field 832 and add/remove buttons 833.

The monitor subject IP address inputting field 831 is where the system administrator designates the IP address in the management network 170 of a storage subsystem to be set as a monitor subject. In the example of FIG. 6A, “192.168.0.3”, “192.168.0.4”, “192.168.0.5” and “192.168.0.6” are entered as the IP addresses of Casing One, Casing Two, Casing Three and Casing Four, respectively.

The storage subsystem ID inputting field 832 is where the system administrator designates the storage subsystem ID of a storage subsystem that is to be set as a monitor subject. In the example of FIG. 6A, Casing One, Casing Two, Casing Three and Casing Four are entered.

The add/remove buttons 833 are used by the system administrator to add or remove a monitor subject storage subsystem.

To newly add a monitor subject storage subsystem, the system administrator operates an add button (by, for example, pointing the cursor to an “add” icon on the screen and clicking the mouse on the icon), causing a new blank row to appear in the monitor subject inputting field 830. The system administrator enters the IP address and storage subsystem ID of the storage subsystem that is to be added as a new monitor subject.

To remove a monitor subject storage subsystem, the system administrator operates a remove button that is on the row where the storage subsystem to be removed is displayed (by, for example, pointing the cursor to a “remove” icon on the screen and clicking the mouse on the icon). This deletes the row and the monitor subject storage subsystem that has been displayed in the row is removed from monitor subjects.

The system administrator operates the enter button 840 to register settings that are currently displayed on the monitoring setting screen 800 in the monitoring settings information 221.

The system administrator operates the cancel button 850 to cancel settings that are currently displayed on the monitoring setting screen 800. This enables the system administrator to set anew.

FIG. 6B is an explanatory diagram of the monitoring settings information 221 set on the monitoring setting screen of FIG. 6A according to the first embodiment of this invention.

The monitoring settings information 221 is, as shown in FIG. 2, stored in the memory 204 of the management computer 140. In the following description, what has been described above with reference to FIG. 6A will not be described.

The monitoring settings information 221 is composed of a monitoring interval 910 and a monitor subject table 920.

The monitoring interval 910 indicates a value set in the monitoring interval inputting field 820 of FIG. 6A.

The monitor subject table 920 holds information related to storage subsystems that are monitored by the management computer 140.

A monitor subject IP address 921 and a storage subsystem ID 922 indicate values set in the monitor subject inputting field 831 and the storage subsystem ID inputting field 832, respectively.

I/O controllable/uncontrollable 923 indicates for each storage subsystem whether I/O can be delayed or not.

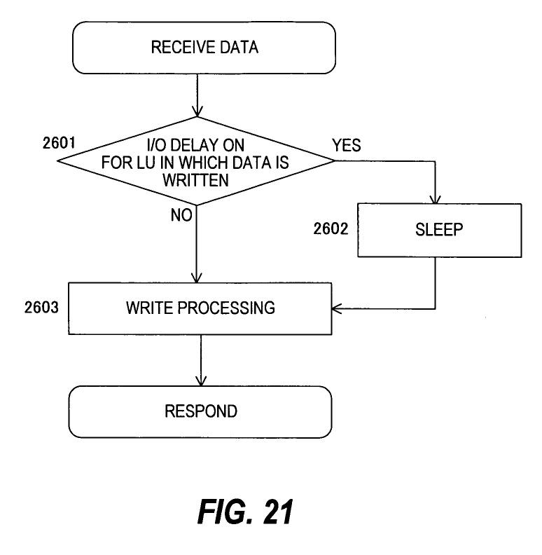

I/O control (delay) in this embodiment is to control input to and output from (I/O) a storage subsystem. Specifically, as will be described with reference to FIG. 21, I/O control is processing that causes a storage subsystem to intentionally delay responding to a write command. I/O delay is executed by the I/O delay processing program 312 of a storage subsystem. Accordingly, whether I/O delay can be implemented or not is determined by whether or not a storage subsystem in question has the I/O delay processing program 312.

In the computer system shown in FIGS. 1 to 5, the direct-coupled storage subsystem 100 (Casing One) and the remote storage subsystems 110 (Casing Two and Casing Three) each of which has the I/O delay processing program 312 can implement I/O delay. Therefore, “controllable” is entered as the I/O controllable/uncontrollable 923 in entries for Casing One, Casing Two and Casing Three.

On the other hand, the remote storage subsystem 120 (Casing Four), which does not have the I/O delay processing program 312, cannot implement I/O delay. “Uncontrollable” is therefore entered as the I/O controllable/uncontrollable 923 in an entry for Casing Four.

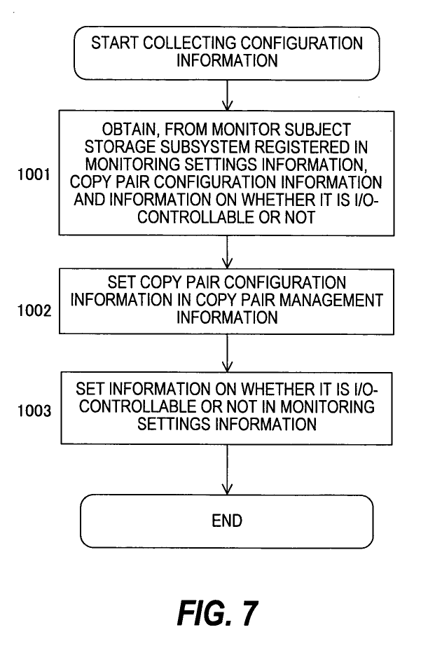

Values representing “controllable” and “uncontrollable” as the I/O controllable/uncontrollable 923 are obtained from each storage subsystem and set by the configuration information collecting program 212 as shown in FIG. 7.

Steps of setting the monitoring settings information 221 will be described. The steps are executed by the monitoring information setting program 211.

The monitoring information setting program 211 is, as shown in FIG. 2, stored in the memory 204 of the management computer 140 and executed by the CPU 202. The monitoring information setting program 211 is a program that sets the monitoring settings information 221 upon receiving an input from the system administrator.

When started up, the monitoring information setting program 211 causes the display device 203 to display the monitoring setting screen 800.

The monitoring information setting program 211 next receives an input from the system administrator through the input device 201.

Then the monitoring information setting program 211 registers the information entered by the system administrator in the monitoring settings information 221.

With the above steps finished, the execution of the monitoring information setting program 211 is completed.

FIG. 7 is a flow chart of the configuration information collecting program 212 in the management computer 140 according to the first embodiment of this invention.

The configuration information collecting program 212 is, as shown in FIG. 2, stored in the memory 204 of the management computer 140 and executed by the CPU 202. The configuration information collecting program 212 is a program that obtains information from a monitor subject storage subsystem to set the I/O controllable/uncontrollable 923 and the copy pair management information 222.

When started up, the configuration information collecting program 212 obtains information on copy pair configurations and information on whether a storage subsystem is I/O-controllable or not from a monitor subject storage subsystem set in the monitoring settings information 221 (1001). Information on copy pair configurations is held in the copy pair configuration information 322 in each storage subsystem (the copy pair configuration information 322 will be described later). The direct-coupled storage subsystem 100 and the remote storage subsystems 110, which have the I/O delay processing program 312, are I/O-controllable whereas the remote storage subsystem 120, which does not have the I/O delay processing program 312, is not I/O-controllable (uncontrollable).

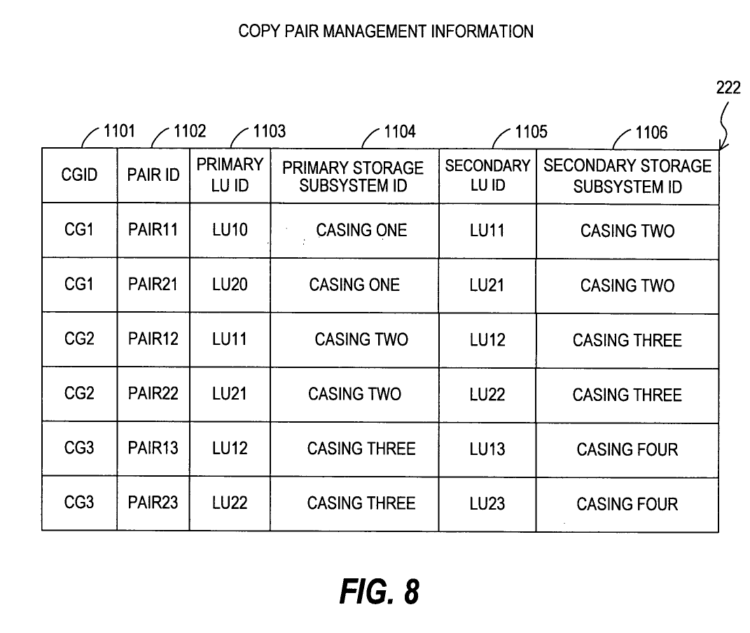

Next, the configuration information collecting program 212 sets, in the copy pair management information 222, the copy pair configuration information obtained in the step 1001 (1002). The thus set copy pair management information 222 will be described in detail with reference to FIG. 8.

The configuration information collecting program 212 then sets, as the I/O controllable/uncontrollable 923 in the monitoring settings information 221, the information obtained in the step 1001, namely, the information on whether a storage subsystem is I/O-controllable or not (1003). The thus set I/O controllable/uncontrollable 923 is as shown in FIG. 6B.

With the above steps finished, the execution of the configuration information collecting program 212 is completed.

In this embodiment, the configuration information collecting program 212 obtains necessary information from each storage subsystem. Alternatively, the information may be entered by the system administrator with the use of the input device 201.

FIG. 8 is an explanatory diagram of the copy pair management information 222 stored in the management computer 140 according to the first embodiment of this embodiment.

The copy pair management information 222 is set by the configuration information collecting program 212, and stored in the memory 204 of the management computer 140 as shown in FIGS. 2 and 7. The copy pair management information 222 shown in FIG. 8 is of when copy pairs formed are as shown in FIG. 1.

The copy pair management information 222 is in a table format in which one row corresponds to one copy pair 601.

In the copy pair management information 222, a CG ID 1101 indicates the identifiers of the consistency groups (CGs) 602 to which the respective copy pairs 601 belong. In this embodiment, there are three CGs 602 as shown in FIG. 1. Accordingly, a cell of the CG ID 1101 holds one of “CG1”, “CG2” and “CG3”.

A pair ID 1102 indicates the identifier of each copy pair 601. In this embodiment, there are six copy pairs 601 as shown in FIG. 1. For the two copy pairs 601 that belong to CG1, “Pair11” and “Pair21” are stored as the pair ID 1102. For the two copy pairs 601 that belong to CG2, “Pair12” and “Pair22” are stored as the pair ID 1102. For the two copy pairs 601 that belong to CG3, “Pair13” and “Pair23” are stored as the pair ID 1102.

A primary LU ID 1103 indicates the identifier of one of the LUs 331 that serves as the primary LU in each copy pair 601. In this embodiment, eight LUs 331 form six copy pairs 601 as shown in FIG. 1. Of the eight LUs 331, six LUs 331 serve as primary LUs. Stored as the primary LU ID 1103 for Pair11, Pair21, Pair12, Pair22, Pair13 and Pair23 are “LU10”, “LU20”, “LU11”, “LU21”, “LU12” and “LU 22”, respectively.

A primary storage subsystem ID 1104 indicates the identifier of a storage subsystem that contains one of the LUs 331 that serves as the primary LU in each copy pair 601. In this embodiment, four storage subsystems contain the LUs 331 as shown in FIG. 1. Of the four, three storage subsystems contain primary LUs 331. An identifier given as the primary storage subsystem ID 1104 to the storage subsystem that contains LU10 and LU20 is “Casing One”. An identifier given as the primary storage subsystem ID 1104 to the storage subsystem that contains LU11 and LU21 is “Casing Two”. An identifier given as the primary storage subsystem ID 1104 to the storage subsystem that contains LU12 and LU22 is “Casing Three”.

A secondary LU ID 1105 indicates the identifier of one of the LUs 331 that serves as the secondary LU in each copy pair 601. In this embodiment, six LUs 331 serve as secondary LUs. Stored as the secondary LU ID 1105 for Pair11, Pair21, Pair12, Pair22, Pair13 and Pair23 are “LU11”, “LU21”, “LU12”, “LU22”, “LU13” and “LU 23”, respectively.

A secondary storage subsystem ID 1106 indicates the identifier of a storage subsystem that contains one of the LUs 331 that serves as the secondary LU in each copy pair 601. In this embodiment, three storage subsystems contain secondary LUs 331. An identifier given as the secondary storage subsystem ID 1106 to the storage subsystem that contains LU11 and LU21 is “Casing Two”. An identifier given as the secondary storage subsystem ID 1106 to the storage subsystem that contains LU12 and LU22 is “Casing Three”. An identifier given as the secondary storage subsystem ID 1106 to the storage subsystem that contains LU13 and LU23 is “Casing Four”.

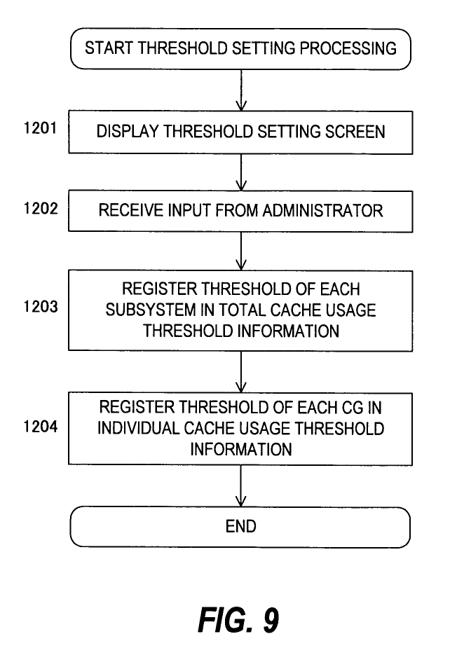

FIG. 9 is a flow chart of the threshold setting program 213 in the management computer 140 according to the first embodiment of this invention.

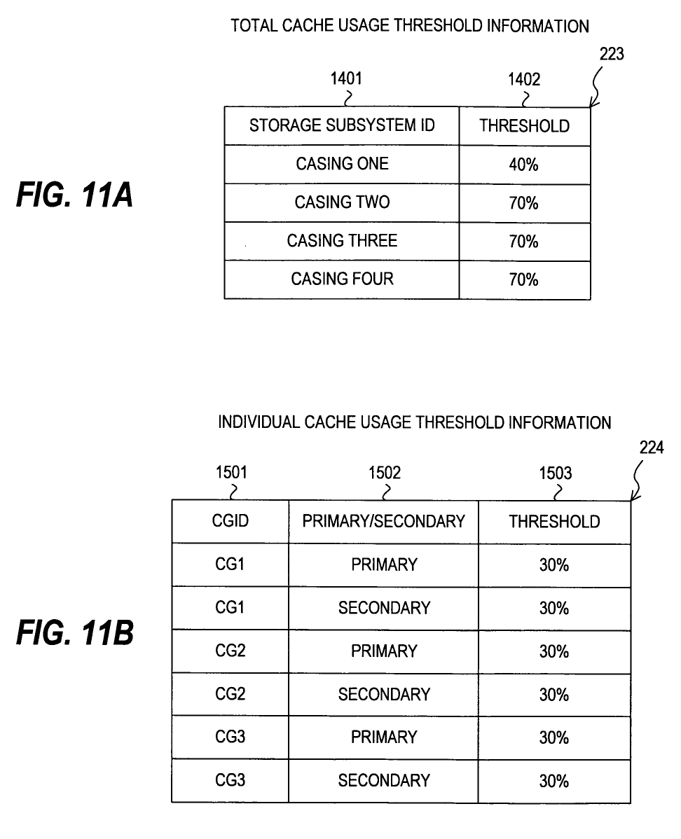

The threshold setting program 213 is, as shown in FIG. 2, stored in the memory 204 of the management computer 140 and executed by the CPU 202. The threshold setting program 213 is a program that sets a usage threshold to a cache memory of a monitor subject storage subsystem. Specifically, the threshold setting program 213 sets the total cache usage threshold information 223 and the individual cache usage threshold information 224 upon receiving an input from the system administrator. The threshold information 223 and 224 will be described later in detail with reference to FIGS. 11A and 11B.

When started up, the threshold setting program 213 causes the display device 203 to display a threshold setting screen (1201).

The threshold setting program 213 next receives an input from the system administrator through the input device 201 (1202).

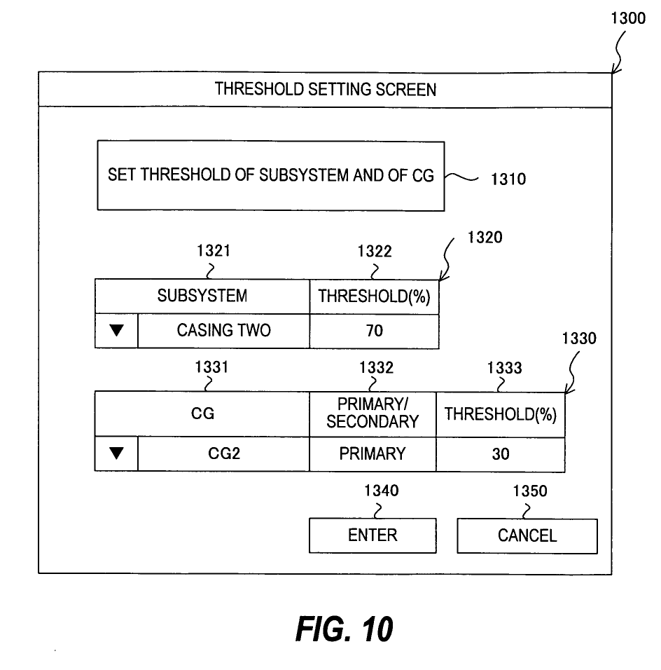

An example of the threshold setting screen displayed in the step 1201 and an example of values set in the step 1202 will be given with reference to FIG. 10.

Next, the threshold setting program 213 sets the total cache usage threshold information 223 for each storage subsystem based on the information entered by the system administrator in the step 1202 (1203).

Next, the threshold setting program 213 sets the individual cache usage threshold information 224 for each storage subsystem based on the information entered by the system administrator in the step 1202 (1204).

With the above steps finished, the execution of the threshold setting program 213 is completed.

FIG. 10 is an explanatory diagram of the threshold setting screen displayed on the management computer 140 according to the first embodiment of this invention.

A threshold setting screen 1300 of FIG. 10 is displayed on the display device 203 of the management computer 140 by the threshold setting program 213 (the step 1201 of FIG. 9). The threshold setting screen 1300 provides a GUI with which the system administrator sets the total cache usage threshold information 223 and the individual cache usage threshold information 224.

The threshold setting screen 1300 is composed of a comment displaying field 1310, a total cache usage threshold inputting field 1320, an individual cache usage threshold inputting field 1330, an enter button 1340, and a cancel button 1350.

The comment displaying field 1310 is where a comment is displayed to prompt the system administrator to set a usage threshold to the cache memory 303 of each monitor subject storage subsystem and CG 602.

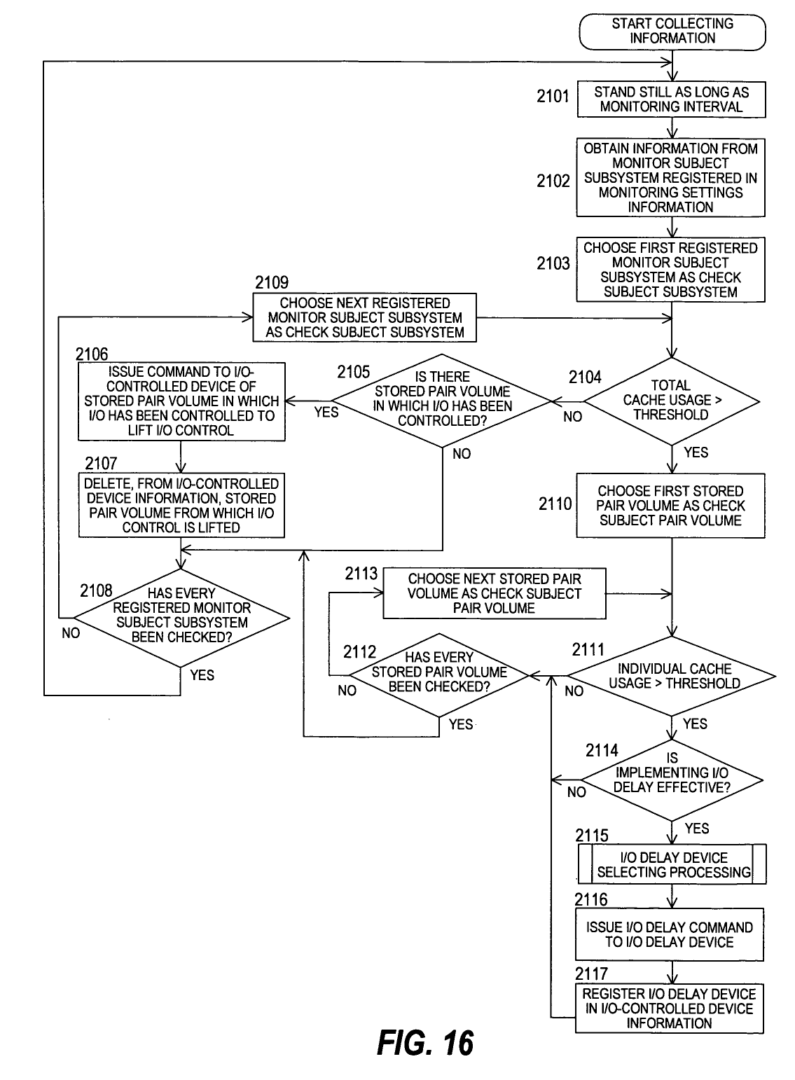

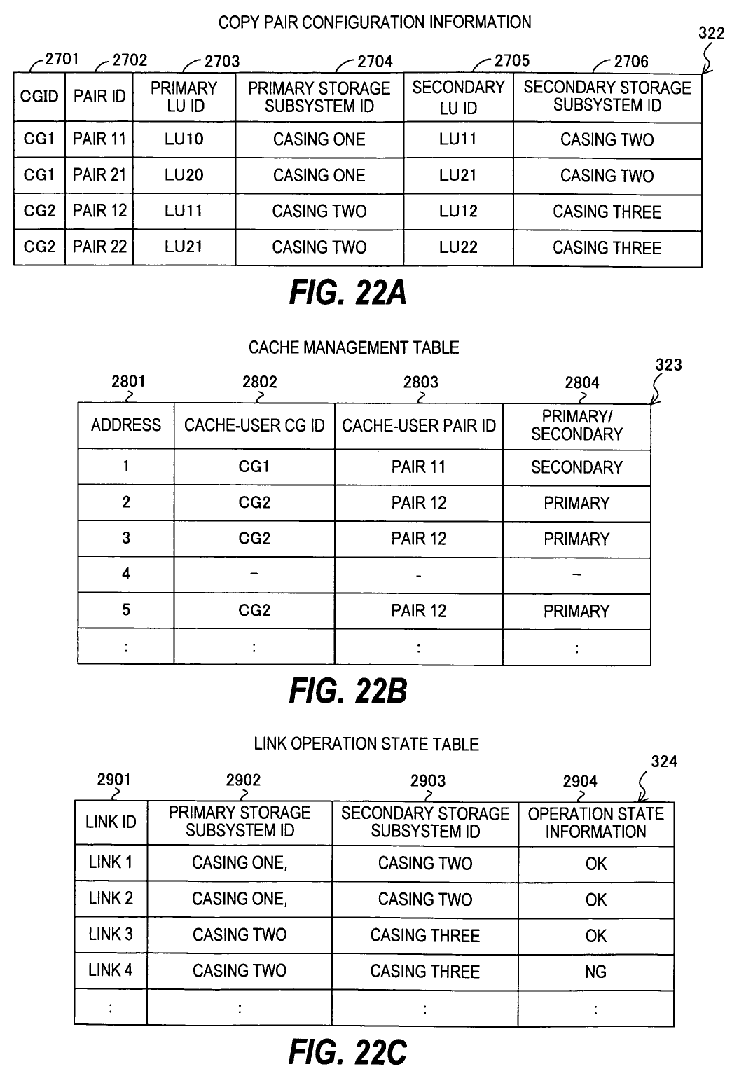

The total cache usage threshold inputting field 1320 is where the system administrator sets a total cache usage threshold. A total cache usage threshold is a value set for each storage subsystem and consulted by the information collecting program 215 to judge whether I/O delay is to be implemented or not as shown in FIGS. 16 and 22.

The total cache usage threshold inputting field 1320 is composed of a storage subsystem selecting field 1321 and a threshold inputting field 1322.

The system administrator operates the storage subsystem selecting field 1321 to choose a storage subsystem to which a threshold is to be set in the threshold inputting field 1322. Specifically, the system administrator operates a downward-pointing triangle in the storage subsystem selecting field 1321 (by, for example, clicking on the triangle with the mouse) to have a list of monitor subject storage subsystem IDs displayed as a pull-down menu (not shown). The system administrator chooses from the displayed storage subsystem IDs the identifier of a storage subsystem to which a threshold is to be set.

The system administrator then enters a threshold in the threshold inputting field 1322 for the storage subsystem chosen. The value entered here is set as a total cache usage threshold of the storage subsystem chosen. In the example of FIG. 10, “70%” is set as the total cache usage threshold of the cache memory 303 of Casing Two. The total cache usage threshold set here is registered in the total cache usage threshold information 223 shown in FIG. 11A.

The individual cache usage threshold inputting field 1330 is where the system administrator sets an individual cache usage threshold. An individual cache usage threshold is a value set for a primary cache and a secondary cache of each CG 602 and consulted by the information collecting program 215 to judge which CG 602 is to undergo I/O delay as shown in FIGS. 16 and 22.

The individual cache usage threshold inputting field 1330 is composed of a CG selecting field 1331, a primary/secondary displaying field 1332, and a threshold inputting field 1333.

The system administrator operates the CG selecting field 1331 to choose a CG 602 to which a threshold is to be set in the threshold inputting field 1333. Specifically, the system administrator operates a downward-pointing triangle in the CG selecting field 1331 to have a list of CG IDs of CGs 602 to which LUs 331 contained in monitor subject storage subsystems belong displayed as a pull-down menu (not shown).

However, in the example of example FIG. 10, the individual cache usage threshold inputting field 1330 is in conjunction with the total cache usage threshold inputting field 1320, and only the pair IDs of the CGs 602 that are associated with the storage subsystem chosen in the storage subsystem selecting field 1321 (i.e., the CGs 602 to which the LUs 331 contained in the chosen storage subsystem belong) are displayed on the above pull-down menu. In the example of example FIG. 10, Casing Two is chosen and therefore the CG IDs “CG1” and “CG2” which are associated with Casing Two are displayed on the pull-down menu of the CG selecting field 1331 (not shown). The system administrator chooses from the displayed CG IDs the identifier of the CG 602 to which a threshold is to be set.

The primary/secondary displaying field 1332 displays whether the cache memory 303 to which a threshold is to be set in the threshold inputting field 1333 is the primary cache or the secondary cache of the CG 602 that is chosen in the CG selecting field 1331.

The system administrator then enters a threshold in the threshold inputting field 1333 for the CG 602 chosen. The value entered here is set as an individual cache usage threshold of the CG 602 chosen. In the example of FIG. 10, “30%” is set as the individual cache usage threshold of a primary cache of CG2 contained in the cache memory 303 of Casing Two. The individual cache usage threshold set here is registered in the individual cache usage threshold information 224 shown in FIG. 11B.

The system administrator operates the enter button 1340 to register settings that have been set up to that point on the threshold setting screen 1300 in the total cache usage threshold information 223 and the individual cache usage threshold information 224.

The system administrator operates the cancel button 1350 to cancel settings that have been set up to that point on the threshold setting screen 1300. This enables the system administrator to set anew.

FIG. 11A is an explanatory diagram of the total cache usage threshold information 223 stored in the management computer 140 according to the first embodiment of this invention.

The total cache usage threshold information 223 is set by the threshold setting program 213 as shown in FIGS. 9 and 10, and stored in the memory 204 of the management computer 140 as shown in FIG. 2.

The total cache usage threshold information 223 is composed of a storage subsystem ID 1401 and a threshold 1402.

The storage subsystem ID 1401 indicates the identifier of a monitor subject storage subsystem. In this embodiment, as shown in FIG. 1, Casing One, Casing Two, Casing Three, and Casing Four are subjects to be monitored.

The threshold 1402 indicates a total cache usage threshold (i.e., a threshold of the usage of the cache memory 303 set for each storage subsystem). Specifically, the threshold 1402 indicates a threshold of the ratio of the data amount combined between the area used as the primary cache and the area used as the secondary cache to the capacity of the cache memory 303 of each storage subsystem. In the example of FIG. 11A, “40%”, “70%”, “70%”, and “70%” are set as the threshold 1402 for Casing One, Casing Two, Casing Three, and Casing Four, respectively.

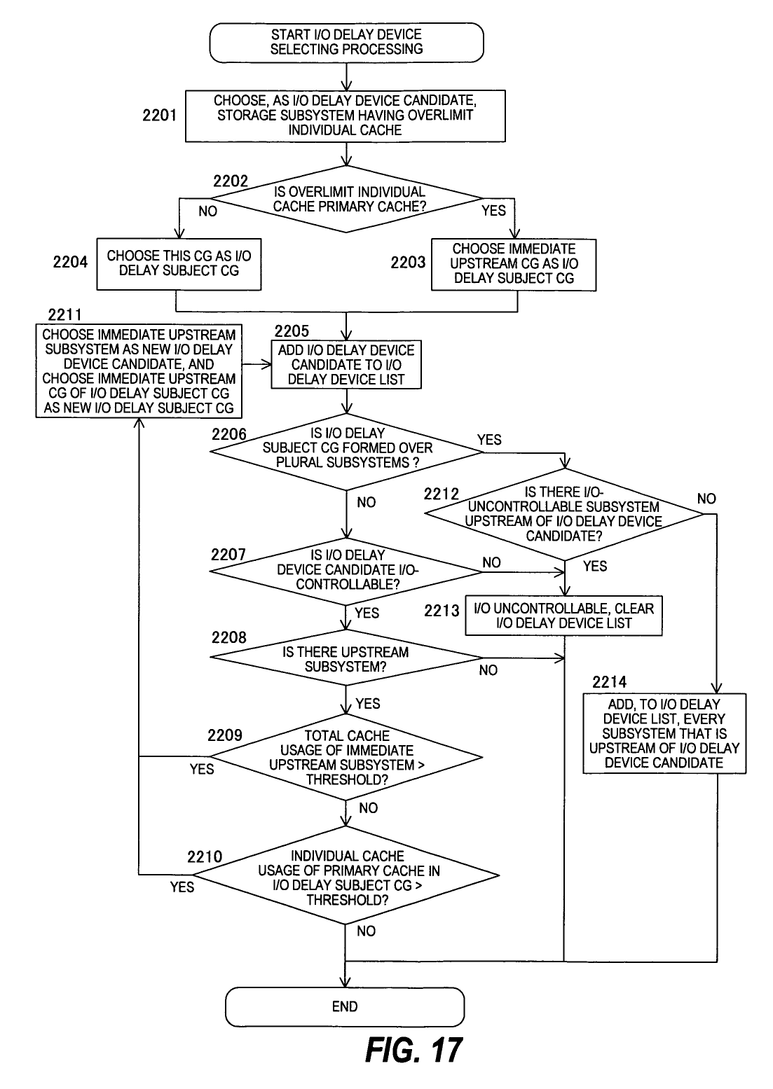

For instance, when the sum of the data amount of the area used as the primary cache and the area used as the secondary cache in the cache memory 303 of Casing Four exceeds 70% of the capacity of the cache memory 303 of Casing Four, namely, the threshold 1402 set for Casing Four, I/O delay is implemented in one of the storage subsystems. Details thereof will be described with reference to FIG. 16 and FIG. 17.

FIG. 11B is an explanatory diagram of the individual cache usage threshold information 224 stored in the management computer 140 according to the first embodiment of this invention.

The individual cache usage threshold information 223 is set by the threshold setting program 213 as shown in FIGS. 9 and 10, and stored in the memory 204 of the management computer 140 as shown in FIG. 2.

The individual cache usage threshold information 224 is composed of a CG ID 1501, primary/secondary 1502, and a threshold 1503.

The CG ID 1501 indicates the identifier of the CG 602 that is associated with a monitor subject storage subsystem. In this embodiment, CG1, CG2, and CG3 are set as the CG ID 1501 for the three CGs 602 shown in FIG. 1.

The primary/secondary 1502 indicates whether it is a primary cache or a secondary cache.

The threshold 1503 indicates an individual cache usage threshold (i.e., a threshold of the usage of the cache memory 303 set for each CG 602). Specifically, the threshold 1503 indicates a threshold of the ratio of the data amount of the area used as the primary cache or the area used as the secondary cache of each CG 602 to the capacity of the cache memory 303 of each storage subsystem. In the example of FIG. 11B, “30%” is set as the threshold 1503 for the primary cache and the secondary cache of every CG 602.

For instance, the cache memory 303 of Casing Three can contain an area serving as the secondary cache of CG2 and an area serving as the primary cache of CG3. In the example of FIG. 11B, 30% is set as the threshold 1503 for the secondary cache of CG2. Then, if the data amount of the secondary cache of CG2 exceeds 30% of the capacity of the cache memory 303 of Casing Three, I/O delay is implemented in CG2 or in the CG 602 that is upstream of CG2. The same principle applies to the primary and secondary caches of other CGs 602. Details thereof will be described with reference to FIG. 16 and FIG. 17.

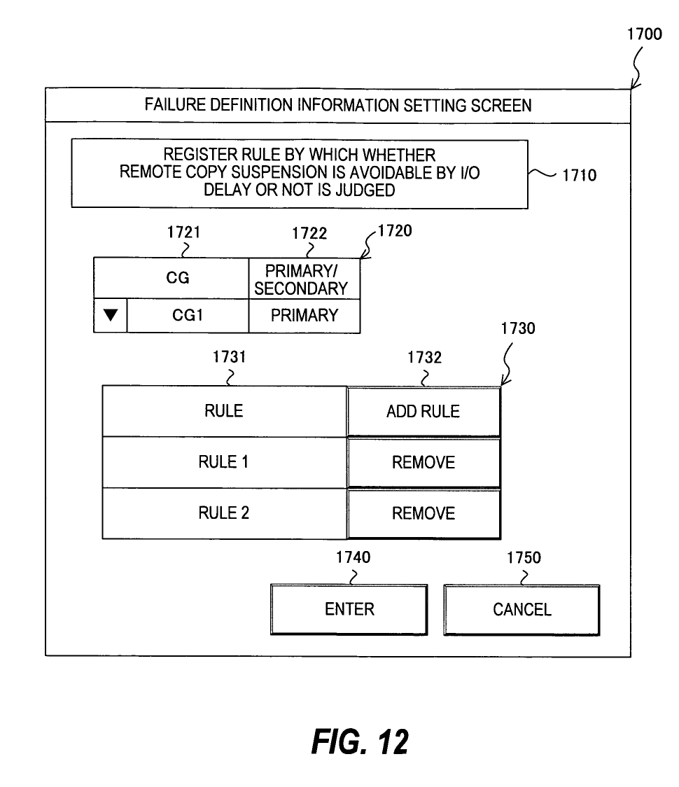

FIG. 12 is an explanatory diagram of a failure definition information setting screen displayed on the management computer 140 according to the first embodiment of this invention.

A failure definition information setting screen 1700 of FIG. 12 is displayed on the display device 203 of the management computer 140 by the failure definition information setting program 214. The failure definition information setting screen 1700 provides a GUI with which the system administrator sets the failure definition information 225.

The failure definition information 225 is about a rule by which whether implementing I/O delay is effective or not (in other words, whether or not implementing I/O delay prevents the cache memory 303 from overflowing to thereby avoid suspending copy pair 601) is judged for the primary cache and secondary cache of each CG 602. Suspension of copy pair 601 means suspension of remote copy in the copy pair 601.

The failure definition information setting screen 1700 is composed of a comment displaying field 1710, a rule setting subject inputting field 1720, a rule setting field 1730, an enter button 1740, and a cancel button 1750.

The comment displaying field 1710 is where a comment is displayed to prompt the system administrator to set the failure definition information 225 (i.e., rules by which whether or not suspension of copy pair 601 can be avoided by implementing I/O delay is judged).

The rule setting subject inputting field 1720 is where the system administrator enters the primary or secondary cache of the CG 602 to which a rule is to be set.

The rule setting subject inputting field 1720 is composed of a CG selecting field 1721 and a primary/secondary selecting field 1722.

The system administrator operates the CG selecting field 1721 to choose the CG 602 to which a rule is to be set. Specifically, a downward-pointing triangle in the CG selecting field 1721 is operated to display, as a pull-down menu (not shown), a list of CG IDs of the CGs 602 to which the LUs 331 contained in monitor subject storage subsystems belong. The system administrator chooses from the displayed CG IDs the identifier of the CG 602 to which a rule is to be set.

The system administrator then specifies, in the primary/secondary selecting field 1722, whether it is the primary cache or secondary cache of the CG 602 chosen in the CG selecting field 1721 that a rule is to be set upon. As in the CG selecting field 1721, a pull-down menu (not shown) may be displayed in the primary/secondary selecting field 1722 to present the options, primary or secondary, to choose from.

The rule setting field 1730 is where the system administrator designates which rule is set to the subject chosen in the rule setting subject inputting field 1720.

The rule setting field 1730 is composed of a rule inputting field 1731, and add/remove buttons 1732.

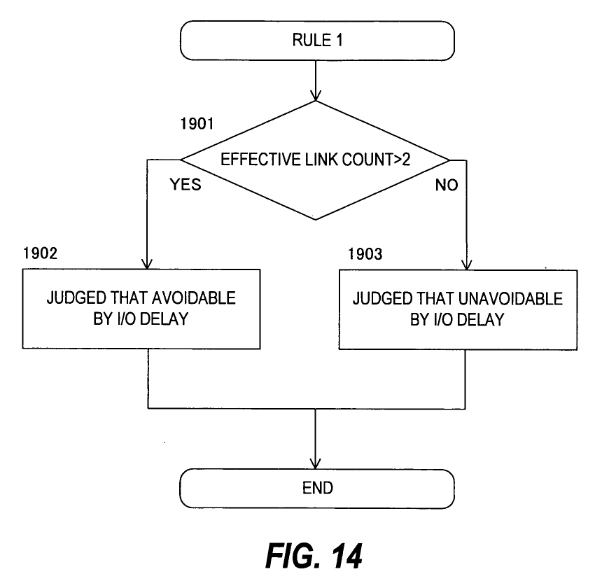

The rule inputting field 1731 is where the system administrator enters a defined rule. In the example of FIG. 12, “Rule1” and “Rule2” are entered. An example of a defined rule will be described later in detail with reference to FIG. 14.

The add/remove buttons 1732 are used by the system administrator to add or remove a rule.

The system administrator operates an add rule button of the add/remove buttons 1732, creating a new row of the rule setting field 1730. The system administrator enters an arbitrary rule in the new row of the rule setting field 1731 to add the arbitrary row. The system administrator operates a remove rule button of the add/remove buttons 1732 to remove a rule that is displayed next to the operated button.

In the case where plural rules are set to one subject, the logical product of the rules, for example, is employed as the ultimate rule to be applied to this subject.

The system administrator operates the enter button 1740 to register settings that have been set up to that point on the failure definition information setting screen 1700 in the failure definition information 225.

The system administrator operates the cancel button 1750 to cancel settings that have been set up to that point on the failure definition information setting screen 1700. This enables the system administrator to set anew.

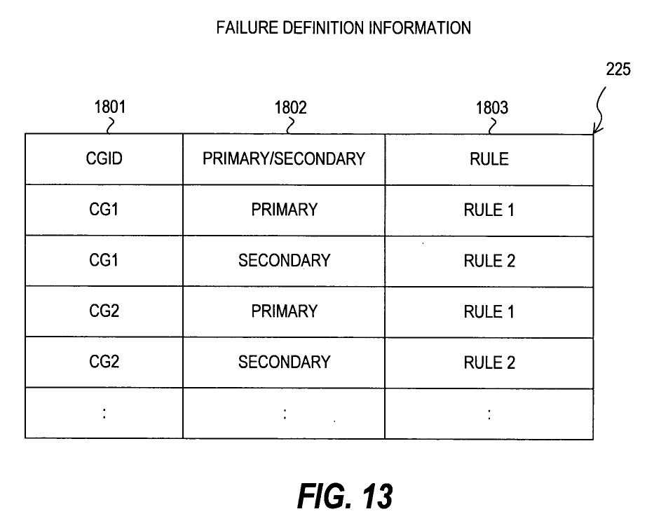

FIG. 13 is an explanatory diagram of the failure definition information 225 stored in the management computer 140 according to the first embodiment of this invention.

The failure definition information 225 is set by the failure definition information setting program 214, and stored in the memory 204 of the management computer 140 as shown in FIG. 2.

The failure definition information 225 is composed of a CG ID 1801, secondary/primary 1802, and a rule 1803.

The CG ID 1801 indicates the identifier of the CG 602 that is associated with a monitor subject storage subsystem. In this embodiment, the identifiers of the three CGs 602 shown in FIG. 1 are set as the CG ID 1801. In FIG. 13, only the identifiers CG1 and CG2 are shown while the rest is omitted.

The primary/secondary 1802 indicates whether it is a primary cache or a secondary cache.

The rule 1803 indicates for each CG 602 which rule is applied. In the example of FIG. 13, Rule1 is applied to the primary cache in every CG 602 whereas Rule2 is applied to the secondary cache in every CG 602.

Steps of setting the failure definition information 225 will be described. The steps are executed by the failure definition information setting program 214.

The failure definition information setting program 214 is, as shown in FIG. 2, stored in the memory 204 of the management computer 140 and executed by the CPU 202. The failure definition information setting program 214 sets the failure definition information 225 upon receiving an input from the system administrator.

When started up, the failure definition information setting program 214 causes the display device 203 to display the failure definition information setting screen 1700.

The failure definition information setting program 214 next receives an input from the system administrator through the input device 201.

Then the failure definition information setting program 214 registers, in the failure definition information 225, the information entered by the system administrator.

With the above steps finished, the execution of the failure definition information setting program 214 is completed.

FIG. 14 is an explanatory diagram of an example of a rule applied in the first embodiment of this invention.

The example of FIG. 14 illustrates Rule1 shown in FIGS. 12 and 13.

According to Rule1, whether or not the effective link count (i.e., the count of links 160 that are usable) is larger than “2” is judged first (1901). The links 160 that are subjects of the judgment here are those downstream of the primary cache to which the rule is applied. For instance, in the case where Rule One is applied to the primary cache of CG1 in FIG. 1, how many of the links 160 between Casing One and Casing Two are usable is counted. In order to obtain the effective link count, operation state information 2904 of the link operation state table 324 may be consulted.

When the effective link count is larger than “2” in the step 1901, it is judged that an overflow of the cache memory 303 and suspension of copy pair 601 can be avoided by implementing I/O delay (in short, I/O delay is judged as effective) (1902).

On the other hand, when the effective link count is not larger than “2” in the step 1901, it is judged that an overflow of the cache memory 303 and suspension of copy pair 601 cannot be avoided by implementing I/O delay (in short, I/O delay is judged as not effective) (1903).

The threshold used in the judging in the step 1901 is not limited to “2”, and how many usable links are necessary to ensure a satisfactory transfer performance is set in accordance with the scale, performance, and the like of the computer system. When the effective link count of a cache is large enough to ensure a satisfactory transfer performance, it is judged that implementing I/O delay is effective for the cache.

Note that FIG. 14 shows an example of what rule is applied in this embodiment, and that the system administrator can set an arbitrary rule.

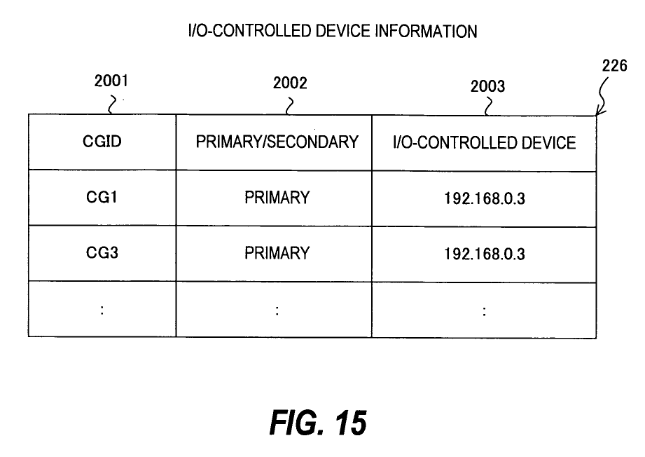

FIG. 15 is an explanatory diagram of the I/O-controlled device information 226 stored in the management computer 140 according to the first embodiment of this invention.

The I/O-controlled device information 226 is, as shown in FIG. 2, stored in the memory 204 of the management computer 140. The I/O-controlled device information 226 contains information on a storage subsystem that has received an I/O delay command. As will be described with reference to FIG. 16, information contained in the I/O-controlled device information 226 is newly registered, or is deleted, by the information collecting program 215.

The I/O-controlled device information 226 is composed of a CG ID 2001, primary/secondary 2002, and an I/O-controlled device 2003. The CG ID 2001 and the primary/secondary 2002 are information on the CG 602 whose individual cache usage has exceeded a given threshold. The I/O-controlled device 2003 is information on a storage subsystem in which I/O delay is implemented in order to limit the amount of data inputted to this CG 602.

For instance, in the case where the usage of the cache memory 303 of the Casing One in FIG. 1 has exceeded a predetermined threshold, the usage of the primary cache of CG1 has exceeded a predetermined threshold, and, the management computer 140 issues an I/O delay command to Casing One, “CG1” is set as the CG ID 2001, “primary” is set as the primary/secondary 2002, and “192.168.0.3” is set as the I/O-controlled device 2003 in the I/O-controlled device information 226.

Stored as the I/O-controlled device 2003 is an IP address at which the management computer 140 accesses a storage subsystem that is the recipient of an I/O delay command (the I/O-controlled device 2003 corresponds to the monitor subject IP address 921 of FIG. 6B). The storage subsystem that has received the I/O delay command implements I/O delay.

For instance, in the case where the usage of the cache memory 303 of the Casing Three in FIG. 1 has exceeded a predetermined threshold, the usage of the primary cache of CG3 has exceeded a predetermined threshold, and, the management computer 140 issues an I/O delay command to Casing One, “CG3” is set as the CG ID 2001, “primary” is set as the primary/secondary 2002, and “192.168.0.3” is set as the I/O-controlled device 2003 in the I/O-controlled device information 226.

How the management computer 140 decides whether to issue an I/O delay command or not and how the management computer 140 chooses the recipient of an I/O delay command will be described in detail with reference to FIGS. 16 and 17.

FIG. 16 is a flow chart of the information collecting program 215 in the management computer 140 according to the first embodiment of this invention.

The information collecting program 215 is, as shown in FIG. 2, stored in the memory 204 of the management computer 140 and executed by the CPU 202. The information collecting program 215 monitors, at predetermined intervals (monitoring interval), the usage of the cache memory 303 in a storage subsystem. When it is found through monitoring that the usage of the cache memory 303 has exceeded a given threshold, a storage subsystem chosen by the information collecting program 215 is ordered to implement I/O delay.

When started up, the information collecting program 215 stands still for a period set as the monitoring interval 910 (2101). In the case where three minutes are set as the monitoring interval 910 as shown in FIG. 6B, the information collecting program 215 stands still for three minutes.

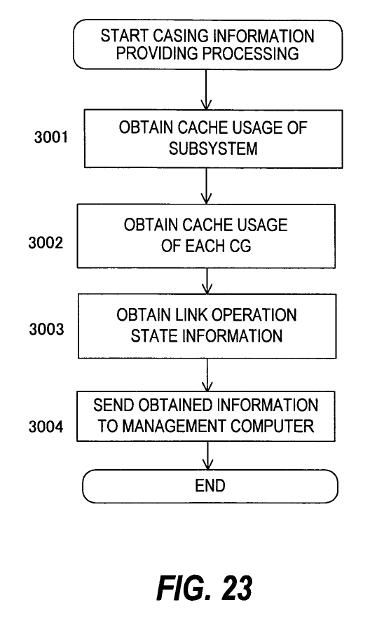

Then the information collecting program 215 collects information from a storage subsystem that is registered as a monitor subject in the monitoring settings information 221 (hereinafter referred to as registered monitor subject subsystem) (2102). To collect information, the information collecting program 215 issues, to each registered monitor subject subsystem, a command requesting information (not shown). Information collected by the information collecting program 215 is, specifically, data contained in the cache management table 323 and link operation state table 324 of each registered monitor subject subsystem. How the tables 323 and 324 and a storage subsystem that has received the command operate will be described later in detail with reference to FIGS. 22A to 22C and FIG. 23.

The information collecting program 215 then chooses, as a check subject, the first registered monitor subject subsystem (2103). Hereinafter, a registered monitor subject subsystem that is chosen as a check subject will be referred to as check subject subsystem. For instance, in the case where the monitoring settings information is as shown in FIG. 6B, Casing One is the first to be chosen as a check subject subsystem.

Next, the information collecting program 215 judges whether or not the total cache usage exceeds the total cache usage threshold (2104). The total cache usage is calculated from the data in the cache management table 323. How to calculate the total cache usage will be described later with reference to FIG. 23. The total cache usage threshold is obtained from the threshold 1402 contained in the total cache usage threshold information 223. For example, in the case where Casing One is the check subject subsystem, the total cache usage threshold is 40%. Accordingly, it is judged that the total cache usage exceeds the total cache usage threshold when the calculated total cache usage is over 40%.

When it is judged in the step 2104 that the total cache usage does not exceed the total cache usage threshold, there is no need to delay I/O in this check subject subsystem. Furthermore, in the case where I/O delay has already been implemented in other storage subsystems than this check subject subsystem in order to prevent the cache memory 303 of this check subject subsystem from overflowing, the I/O delay can be lifted from the storage subsystem.

For that reason, the information collecting program 215 judges whether or not there is a stored pair volume in which I/O has been controlled (2105).

The term pair volume refers to the LU 331 that is identified by a CG ID, a pair ID, and whether it is a primary volume or a secondary volume. For instance, LU11 of FIG. 1 is the secondary pair volume of Pair11 in CG1 and at the same time the primary pair volume of Pair12 in CG2.

The term stored pair volume refers to a pair volume that is stored in a check subject subsystem.

In the step 2105, the information collecting program 215 makes a judgment by consulting the I/O-controlled device information 226. To give an example, in the case where the I/O-controlled device information 226 is as shown in FIG. 15 and Casing Three is the check subject subsystem, it is judged from consultation of the I/O-controlled device information 226 that I/O has been controlled in the primary pair volume of CG3. The primary pair volume of CG3 is held in Casing Three. Accordingly, it is judged in the step 2105 that there is a stored pair volume in which I/O has been controlled.

When it is judged in the step 2105 that there is a stored pair volume in which I/O has been controlled, the I/O control can be lifted from this stored pair volume. Therefore, the information collecting program 215 issues an I/O delay command to lift the I/O control to the I/O-controlled device 2003 that corresponds to the stored pair volume in which I/O has been controlled (2106). For instance, when the stored pair volume that is detected to have been I/O-controlled is the primary pair volume of CG3, an I/O delay command to lift the I/O control from the device is issued to the IP address “192.168.0.3” as shown in the I/O-controlled device 2003 of FIG. 15.

The information collecting program 215 then deletes, from the I/O-controlled device information 226, the stored pair volume from which I/O control is lifted in the step 2106 (2107). For example, the primary pair volume of CG3 and the associated IP address “192.168.0.3” are deleted.

On the other hand, when it is judged in the step 2105 that no stored pair volume has been I/O-controlled, there is no stored paired volume from which I/O control can be lifted. Then the processing proceeds to a step 2108.

In the step 2108, it is judged whether or not every registered monitor subject subsystem has been checked. The check here refers to the processing of the step 2104.

When it is judged in the step 2108 that not all of registered monitor subject subsystems have been checked, the next registered monitor subject subsystem is chosen as a check subject subsystem (2109) and the processing returns to the step 2104.

On the other hand, when it is judged in the step 2108 that every registered monitor subject subsystem has been checked, the processing returns to the step 2101.

When it is judged in the step 2104 that the total cache usage exceeds the total cache usage threshold, the cache memory 303 of the check subject subsystem could be overflown with data. In some cases, however, the overflow can be avoided by implementing I/O delay. For that reason, the information collecting program 215 chooses the first stored pair volume as a check subject (2110). Hereinafter, a stored pair volume that is chosen as a check subject will be referred to as check subject pair volume. To given an example, in the case where the copy pair management information 222 is as shown in FIG. 8, LU10, which is the primary LU 331 of Pair11 in CG1, is the first to be chosen as a check subject pair volume.

Next, the information collecting program 215 judges whether or not the individual cache usage exceeds the individual cache usage threshold for the check subject pair volume (2111). The individual cache usage is calculated from the data in the cache management table 323. How to calculate the individual cache usage will be described later with reference to FIG. 23. The individual cache usage threshold is obtained from the threshold 1503 contained in the individual cache usage threshold information 224. For example, in the case where the check subject pair volume is on the primary side of CG1, the individual cache usage threshold is 30%. Accordingly, it is judged that the individual cache usage exceeds the individual cache usage threshold when the calculated individual cache usage is over 30%.

When it is judged in the step 2111 that the individual cache usage does not exceed the individual cache usage threshold, I/O delay is not implemented in this check subject pair volume. Then the information collecting program 215 judges whether or not every stored pair volume has been checked (2112). The check here refers to the processing of the step 2111.

When it is judged in the step 2112 that every stored pair volume has been checked, it means that the check subject subsystem where the check subject pair volumes are stored has been checked thoroughly. Accordingly, the processing moves to the step 2108 to perform the check on the next registered monitor subject subsystem.

On the other hand, when it is judged in the step 2112 that not all of stored pair volumes have been checked, it means that there are still stored pair volumes left unchecked in the check subject subsystem where the check subject pair volumes are stored. Then the next stored pair volume is chosen as a check subject pair volume (2113) and the processing returns to the step 2111.

When it is judged in the step 2111 that the individual cache usage exceeds the individual cache usage threshold, the cache memory 303 can be prevented in some cases from overflowing by implementing I/O delay in this check subject pair volume.

For that reason, the information collecting program 215 next judges whether I/O delay is effective or not (2114). Specifically, the information collecting program 215 calls up the I/O delay implementation deciding program 216 to judge whether implementing I/O delay is effective or not.

The I/O delay implementation deciding program 216 consults the failure definition information 225 to obtain the rule 1803 that is applied to the check subject pair volume. For example, in the case where the check subject pair volume is the primary volume of CG1, the rule 1803 that is applied to this volume is Rule1. Accordingly, the I/O delay implementation deciding program 216 follows Rule1 shown in FIG. 14 to judge whether implementing I/O delay is effective or not.

When it is judged in the step 2114 that I/O delay is not effective, it means that implementing I/O delay in this check subject pair volume does not stop the cache memory 303 from overflowing. Then the processing moves to the step 2112 to check the next stored pair volume.

On the other hand, when it is judged in the step 2114 that I/O delay is effective, it means that implementing I/O delay in this check subject pair volume can stop the cache memory 303 from overflowing. Accordingly, the information collecting program 215 next executes I/O delay device selecting processing (2115). The I/O delay device selecting processing is processing to select which storage subsystem is to implement I/O delay. Details of this processing will be described with reference to FIG. 17.

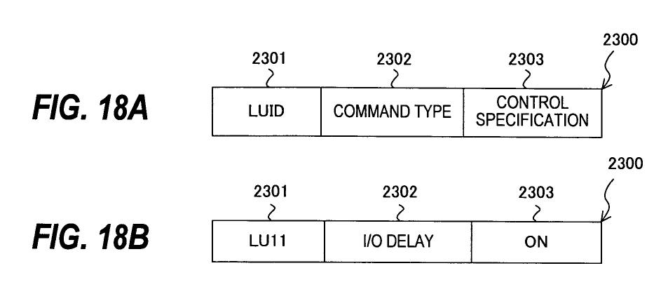

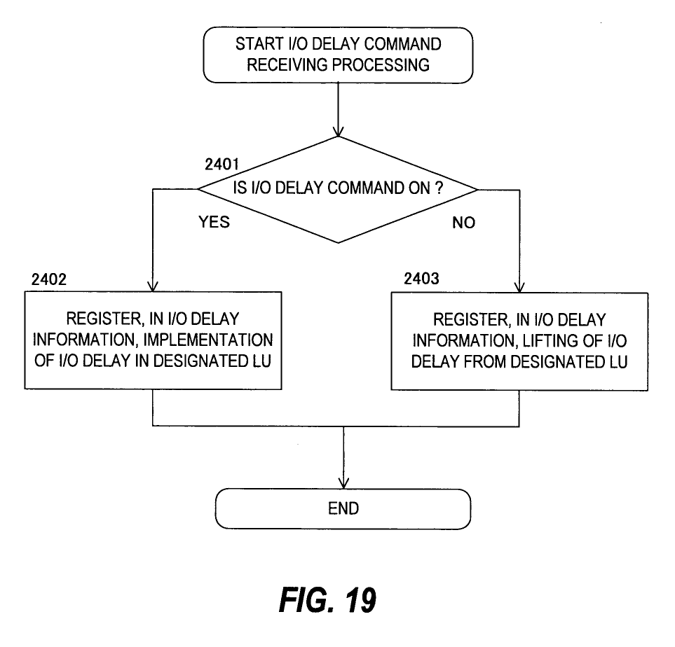

Next, the information collecting program 215 issues an I/O delay command to implement I/O delay to a storage subsystem chosen in the step 2115 (a storage subsystem to be I/O-controlled will be referred to as I/O delay device) (2116). In the I/O delay device to which the command is issued, the I/O delay command receiving program 311 receives the command and the I/O delay processing program 312 implements I/O delay. The processing by the programs 311 and 312 will be described later in detail with reference to FIGS. 19 and 21. The format of the I/O delay command issued in the step 2116 will be described later in detail with reference to FIGS. 18A and 18B.

The information collecting program 215 next registers the I/O delay device in the I/O-controlled device information 226 (2117). Specifically, the information collecting program 215 registers in the I/O-controlled device information 226 information by which the check subject pair volume is identified, namely, a CG ID, a pair ID, and information indicating whether the volume is primary or secondary, and the IP address of the I/O delay device (the monitor subject IP address 921 of this storage subsystem). Then the information collecting program 215 moves to the step 2112 to check the next stored pair volume.

FIG. 17 is a flow chart of I/O delay device selecting processing executed by the information collecting program 215 of the management computer 140 according to the first embodiment of this invention.

The I/O delay device selecting processing is executed by the information collecting program 215 in the step 2115 of FIG. 16.

As the I/O delay device selecting processing is started, the information collecting program 215 first defines a storage subsystem having an overlimit individual cache as an “I/O delay device candidate” (2201).

An overlimit individual cache is a cache of a check subject CG whose individual cache usage is judged as larger than the individual cache usage threshold in the step 2111 of FIG. 16. For example, in the case where the individual cache usage on the primary side of CG3 shown in FIG. 1 is judged as larger than the individual cache usage threshold, the primary cache of CG3 is an overlimit individual cache and Casing Three, which makes the primary side of CG3, is an I/O delay device candidate.

Next, the information collecting program 215 judges whether the overlimit individual cache is a primary cache or not (2202).

When it is judged in the step 2202 that the overlimit individual cache is a primary cache, the information collecting program 215 chooses, as an I/O delay subject CG, the CG 602 that is immediately upstream of the CG 602 that is associated with the overlimit individual cache (2203). For example, when the overlimit individual cache is the primary cache of CG3, CG2 is chosen as an I/O delay subject CG.

On the other hand, when it is judged in the step 2202 that the overlimit individual cache is not a primary cache, it means that the overlimit individual cache is a secondary cache. Then the information collecting program 215 chooses, as an I/O delay subject CG, the CG 602 that is associated with this overlimit individual cache (2204). Here, an I/O delay subject CG refers to the CG 602 that is a subject of I/O (data transfer) delay.

After the step 2203 or 2204 is finished, the information collecting program 215 adds the I/O delay device candidate to an I/O delay device list (not shown) (2205). The I/O delay device list is information of a list of storage subsystems that are chosen through the I/O delay device selecting processing (i.e., storage subsystems in which I/O delay is to be implemented). The I/O delay device list is stored in, for example, the memory 204 of the management computer 140.

The information collecting program 215 next judges whether or not the I/O delay subject CG is formed over plural storage subsystems (2206). One CG 602 is formed over plural storage subsystems when plural copy pairs 601 belong to this CG 602 and at least two sequences of these copy pairs 601 belong to different storage subsystems. Specifically, an I/O delay subject CG is regarded as stretching over plural storage subsystems when the primary LUs 331 or the secondary LUs 331, or the primary LUs 331 and the secondary LUs 331, of pairs contained in the I/O delay subject CG are stored in plural storage subsystems.

To give an example, when CG2 in FIG. 1 is an I/O delay subject CG, LU11, which is the primary LU of Pair12 constituting CG2, and LU21, which is the primary LU of Pair22 constituting CG2, are stored in the same Casing Two. Also, LU12, which is the secondary LU of Pair12, and LU22, which is the secondary LU of Pair22, are stored in the same Casing Three. Accordingly, it is judged that CG2 is not formed over plural storage subsystems.

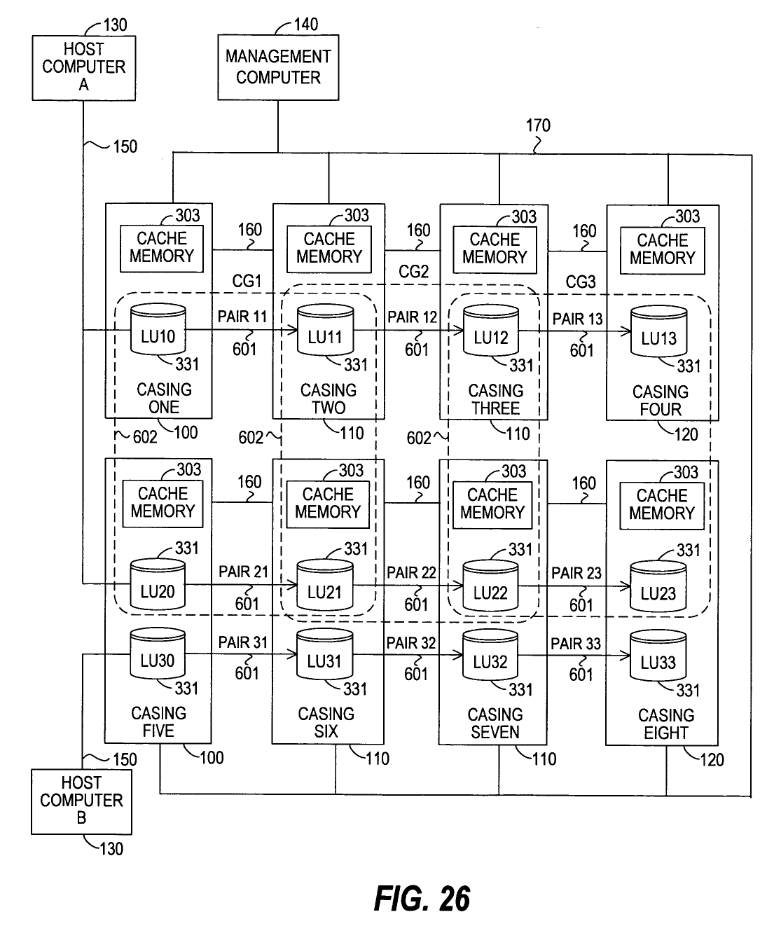

In the configuration shown in FIG. 1, two sequences of copy pairs 601 belong to each CG 602, and no two sequences of copy pairs 601 belong to different storage subsystems. For instance, in each of the two copy pairs 601 belonging to CG1, namely, Pair11 and Pair21, Casing One is the primary side and Casing Two is the secondary side. Therefore, in FIG. 1, there is no case where an I/O delay subject CG is regarded as formed over plural storage subsystems. An example of the configuration where an I/O delay subject CG stretches over plural storage subsystems will be described later in detail with reference to FIG. 26.

When it is judged in the step 2206 that the I/O delay subject CG is formed over plural storage subsystems, the information collecting program 215 judges whether or not there is a storage subsystem that is incapable of implementing I/O delay (i.e., the I/O uncontrollable remote storage subsystem 120 which does not have the I/O delay processing program 312) upstream of the I/O delay device candidate (2212).

When it is judged in the step 2212 that no storage subsystem that is incapable of implementing I/O delay is upstream of the I/O delay device candidate, I/O delay can be implemented. Accordingly, the information collecting program 215 adds, to the I/O delay device list, every storage subsystem that is upstream of the I/O delay device candidate (2214), and ends the processing.

On the other hand, when it is judged in the step 2212 that there is a storage subsystem that is incapable of implementing I/O delay upstream of the I/O delay device candidate, I/O cannot be implemented. Then the information collecting program 215 clears the I/O delay device list (by deleting every data registered on the I/O delay device list) (2213), and ends the processing.

When it is judged in the step 2206 that the I/O delay subject CG is not formed over plural storage subsystems, the information collecting program 215 judges whether the I/O delay device candidate is I/O-controllable or not (2207). Specifically, an I/O delay device candidate is judged as I/O-controllable when the I/O delay device candidate is one of the remote storage subsystems 110, each of which has the I/O delay processing program 312. On the other hand, when an I/O delay device candidate is the remote storage subsystem 120, which does not have the I/O delay control processing program 312, the I/O delay device candidate is judged as not I/O-controllable.

When it is judged in the step 2207 that the I/O delay device candidate is not I/O-controllable, I/O delay cannot be implemented. Therefore, the processing moves to the step 2213.

On the other hand, when it is judged in the step 2207 that the I/O delay device candidate is I/O-controllable, the information collecting program 215 judges whether or not there is a storage subsystem upstream of this I/O delay device candidate (2208).

When it is judged in the step 2208 that there is no storage subsystem upstream of the I/O delay device candidate, the I/O delay device candidate is the direct-coupled storage subsystem 100, upstream of which no storage subsystem is connected. This means that every storage subsystem that is to implement I/O delay has been chosen, and therefore the I/O delay device selecting processing is ended.

On the other hand, when it is judged in the step 2208 that there is a storage subsystem upstream of the I/O delay device candidate, the information collecting program 215 judges whether or not the total cache usage of the storage subsystem that is immediately upstream of the I/O delay device candidate exceeds the total cache usage threshold (2209).

In the case where there is not much free capacity left in the cache memory 303 of the immediate upstream storage subsystem, the cache memory 303 of the immediate upstream storage subsystem is likely to overflow unless the amount of data transferred from a further upstream storage subsystem (or host computer) is controlled. For that reason, whether the cache memory 303 has enough free capacity left or not is judged in the step 2209.

When it is judged in the step 2209 that the total cache usage of the storage subsystem that is immediately upstream of the I/O delay device candidate exceeds the total cache usage threshold, the cache memory 303 of the immediate upstream storage subsystem does not have enough free capacity left. In this case, to avoid an overflow, I/O delay has to be implemented also in a further upstream storage subsystem, which is upstream of the immediate upstream storage subsystem. Accordingly, the information collecting program 215 performs the processing subsequent to the one in the step 2205 on the further upstream storage subsystem. Specifically, the information collecting program 215 chooses, as a new I/O delay device candidate, the immediate upstream storage subsystem of the I/O delay device candidate at the time of the step 2209, and chooses, as s new I/O delay subject CG, the CG 602 that is immediately upstream of the I/O delay subject CG at the time of the step 2209 (2211). The processing then returns to the step 2205.

When it is judged in the step 2209 that the total cache usage of the storage subsystem that is immediately upstream of the I/O delay device candidate is lower than the total cache usage threshold, there is enough free capacity left in the cache memory 303 of the immediate upstream storage subsystem. Then the information collecting program 215 judges whether or not the individual cache usage of the primary cache of the I/O delay subject CG exceeds the individual cache usage threshold (2210).

When the individual cache usage of the primary cache of the I/O delay subject CG exceeds the individual cache usage threshold, the cache memory 303 may not have capacity to spare for other CGs 602 than the I/O delay subject CG, even if it is judged in the step 2209 that there is enough free capacity left in the cache memory 303. Therefore, when it is judged in the step 2210 that the individual cache usage of the primary cache of the I/O delay subject CG exceeds the individual cache usage threshold, the information collecting program 215 moves to a step 2211.

On the other hand, when it is judged in the step 2210 that the individual cache usage of the primary cache of the I/O delay subject CG is lower than the individual cache usage threshold, the information collecting program 215 finishes the I/O delay device selecting processing.

FIGS. 18A and 18B are explanatory diagrams of an I/O delay command issued to a storage subsystem by the management computer 140 according to the first embodiment of this invention.

As the management computer 140 issues an I/O delay command in the step 2116 or 2106 of FIG. 16, I/O delay command data 2300 shown in FIGS. 18A and 18B is transferred from the management computer 140 via the management network 170 to a storage subsystem to which the command is directed. FIG. 18A is a diagram showing the format of the I/O delay command data 2300, and FIG. 18B is a diagram showing an example of the I/O delay command data 2300.

The I/O delay command data 2300 contains, at least, an LU ID 2301, a command type 2302 and a control specification 2303 as shown in FIG. 18A.

The LU ID 2301 indicates the identifier of the LU 331 that is the subject of the I/O delay command. For instance, Pair12 in FIG. 1 is chosen as an I/O delay subject pair and Casing Two is chosen as an I/O delay device through the I/O delay device selecting processing of FIG. 17. In this case, LU11 belonging to Pair12 in Casing Two is the subject of the I/O delay command and “LU11” is written as the LU ID 2301 as shown in FIG. 18B.

The command type 2302 (see FIG. 18A) is information indicating the type of a command issued from the management computer 140. In FIG. 18B, the issued command is an I/O delay command and “I/O delay” is written as the command type 2302.

The control specification 2303 (see FIG. 18A) is information indicating what control is ordered by the management computer 140. In FIG. 18B, when the command is to implement I/O delay as in the step 2116 of FIG. 16, “ON” is written as the control specification 2303, whereas “OFF” is written as the control specification 2303 when the command is to lift I/O delay as in the step 2106 of FIG. 16.

FIG. 19 is a flow chart of the I/O delay command receiving program 311 of a storage subsystem according to the first embodiment of this invention.

In each of the direct-coupled storage subsystem 100 and the remote storage subsystems 110, the I/O delay command receiving program 311 is stored in the memory 306 as shown in FIGS. 3 and 4 and is executed by the processor 304. Upon receiving an I/O delay command issued from the management computer 140 in the step 2116 or 2106 of FIG. 16, the I/O delay command receiving program 311 sets implementation or lift of I/O delay.

Reception of an I/O delay command starts up the I/O delay command receiving program 311, which proceeds to judging whether the received I/O delay command is “ON” (i.e., a command to implement I/O delay) or not (2401). Specifically, the I/O delay command receiving program 311 judges whether or not the I/O delay command data 2300 holds “I/O delay” and “ON” as the command type 2302 and the control specification 2303, respectively.

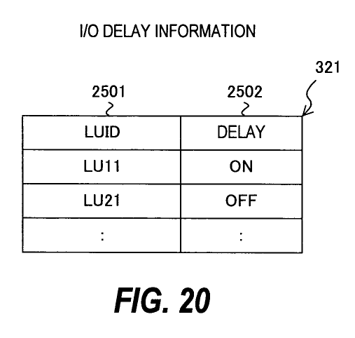

When it is judged in the step 2401 that the received I/O delay command is “ON”, the order is to implement I/O delay. The I/O delay command receiving program 311 therefore registers, in the I/O delay information 321, implementation of I/O delay for the LU ID 2301 designated by the I/O delay command (2402). Details of the I/O delay information 321 will be given later with reference to FIG. 20.

On the other hand, when it is judged in the step 2401 that the received I/O delay command is “OFF”, the order is to lift I/O delay. The I/O delay command receiving program 311 therefore registers, in the I/O delay information 321, lift of I/O delay for the LU ID 2301 that is designated by the I/O delay command (2403).

With the above steps finished, the processing is ended.

FIG. 20 is an explanatory diagram of the I/O delay information 321 stored in a storage subsystem according to the first embodiment of this invention.

In each of the direct-coupled storage subsystem 100 and the remote storage subsystems 110, the I/O delay information 321 is stored in the memory 306 as shown in FIGS. 3 and 4. FIG. 20 shows as an example the I/O delay information 321 that is stored in Casing Two, which is one of the remote storage subsystems 110.

The I/O delay information 321 contains an LU ID 2501 and delay 2502.

The LU ID 2501 indicates the identifier of the LU 331 stored in the storage subsystem where the I/O delay information 321 is stored. Since the I/O delay information 321 in FIG. 20 is of Casing Two, LU11 and LU21 are registered as the LU ID 2501, which are to be stored in Casing Two.

The delay 2502 indicates for each LU 331 whether I/O delay is being implemented or not. When “ON” is held as the delay 2502, it means that I/O delay is being implemented. When “OFF” is held as the delay 2502, it means that I/O delay is not being implemented.

For each LU ID registered as the LU ID 2501, the delay 2502 is set in accordance with the I/O delay command from the management computer 140. For instance, when a command to implement I/O delay in LU11 is issued as shown in FIG. 18B, the delay 2502 for LU11 is “ON” in the I/O delay information 321. Shown in FIG. 20 is the state when the delay 2502 for LU11 is “ON” and the delay 2502 for LU 21 is “OFF”.

FIG. 21 is a flow chart of the I/O delay processing program 312 of a storage subsystem according to the first embodiment of this invention.

In each of the direct-coupled storage subsystem 100 and the remote storage subsystems 110, the I/O delay processing program 312 is stored in the memory 306 as shown in FIGS. 3 and 4, and is executed by the processor 304. The I/O delay processing program 312 implements I/O delay upon receiving an I/O request to write data from the host computer 130, or upon receiving a remote I/O request to write data from an upstream storage subsystem.

Reception of write data starts up the I/O delay processing program 312, which proceeds to search the I/O delay information 321 for the LU 331 in which the received data is to be written. The I/O delay processing program 312 judges whether or not “ON” is registered as the delay 2502 for the LU ID 2501 of the LU 331 in which the received data is to be written (2601).

For example, when the I/O delay information 321 is as shown in FIG. 20 and the received data is to be written in LU11, the delay 2502 that is associated with LU11 is “ON”. In other words, I/O delay is implemented in writing data in LU11. When the received data is to be written in LU 21, the delay 2502 that is associated with LU21 is “OFF”, meaning that I/O delay is not implemented in writing data in LU21.

When it is judged in the step 2601 that “ON” is registered as the delay 2502 for the LU ID 2501 of the LU 331 in which the received data is to be written, the I/O delay processing program 312 implements I/O delay by entering into a sleep mode and staying in the mode for a predetermined period of time (2602). In other words, the I/O delay processing program 312 waits for a predetermined period of time to write data. Thereafter, the I/O delay processing program 312 executes write processing (2603).

On the other hand, when it is judged in the step 2601 that “ON” is not registered as the delay 2502 for the LU ID 2501 of the LU 331 in which the received data is to be written, I/O delay is not implemented and the I/O delay processing program 312 immediately executes write processing instead of entering into a sleep mode (2603).

Thus, data write in the LU 331 that is I/O-controlled is delayed for the length of time the sleep processing (2602) takes. Since the data is written also in the cache memory 303 as a result of the write processing in the step 2603, the cache memory 303 is prevented from overflowing by delaying writing the data through the sleep processing.

FIG. 22A is an explanatory diagram of the copy pair configuration information 322 stored in a storage subsystem according to the first embodiment of this invention.

The copy pair configuration information 322 is, as shown in FIGS. 3 to 5, stored in the memory 306 of each of the direct-coupled storage subsystem 100, the remote storage subsystems 110 and the remote storage subsystem 120. Shown in FIG. 22A as an example is the copy pair configuration information 322 stored in Casing Two, which is one of the remote storage subsystems 110.

The copy pair configuration information 322 is information about the copy pairs 601 formed between storage subsystems. Since the copy pair configuration information 322 shown in FIG. 22A is of Casing Two, it contains information about Pair11, Pair21, Pair12 and Pair22 to which LU11 and LU21 stored in Casing Two belong as shown in FIG. 1.

The copy pair management information 222 stored in the management computer 140 is created by the configuration information collecting program 212 of the management computer 140 by obtaining the contents of the copy pair configuration information 322 from each storage subsystem. A CG ID 2701, a pair ID 2702, a primary LU ID 2703, a primary storage subsystem ID 2704, a secondary LU ID 2705 and a secondary storage subsystem ID 2706 in the copy pair configuration information 322 correspond to the CG ID 1101, the pair ID 1102, the primary LU ID 1103, the primary storage subsystem ID 1104, the secondary LU ID 1105 and the secondary storage subsystem ID 1106 in the copy pair management information 222, respectively. In the following description of the copy pair configuration information 322, the part that is similar to the copy pair management information 222 will be omitted.

In the copy pair configuration information 322, the CG ID 2701 indicates the identifiers of the CGs 602 to which the respective copy pairs 601 belong. Since the copy pair configuration information 322 shown in FIG. 22A is of Casing Two, “CG1” and “CG2” are registered as the CG ID 2701.

The pair ID 2702 indicates the identifier of each copy pair 601. “Pair11” and “Pair21” are registered as the pair ID 2702 for the two copy pairs 601 that belong to CG1. “Pair12” and “Pair22” are registered as the pair ID 2702 for the two copy pairs 601 that belong to CG2.

The primary LU ID 2703 indicates the identifier of one of the LUs 331 that serves as the primary LU in each copy pair 601. Registered as the primary LU ID 2703 for Pair11, Pair21, Pair12 and Pair22 are “LU10”, “LU20”, “LU11” and “LU21”, respectively.

A primary storage subsystem ID 2704 indicates the identifier of a storage subsystem that contains one of the LUs 331 that serves as the primary LU in each copy pair 601. An identifier given as the primary storage subsystem ID 2704 to the storage subsystem that contains LU10 and LU20 is “Casing One”. An identifier given as the primary storage subsystem ID 2704 to the storage subsystem that contains LU11 and LU21 is “Casing Two”.

The secondary LU ID 2705 indicates the identifier of one of the LUs 331 that serves as the secondary LU in each copy pair 601. Registered as the secondary LU ID 2705 for Pair11, Pair21, Pair12 and Pair22 are “LU11”, “LU21”, “LU12” and “LU22”, respectively.

A secondary storage subsystem ID 2706 indicates the identifier of a storage subsystem that contains one of the LUs 331 that serves as the secondary LU in each copy pair 601. An identifier given as the secondary storage subsystem ID 2706 to the storage subsystem that contains LU11 and LU21 is “Casing Two”. An identifier given as the secondary storage subsystem ID 2706 to the storage subsystem that contains LU12 and LU22 is “Casing Three”.

FIG. 22B is an explanatory diagram of the cache management table 323 stored in a storage subsystem according to the first embodiment of this invention.

The cache management table 323 is, as shown in FIGS. 3 to 5, stored in the memory 306 of each of the direct-coupled storage subsystem 100, the remote storage subsystems 110 and the remote storage subsystem 120. Shown in FIG. 22B as an example is the cache management table 323 stored in Casing Two, which is one of the remote storage subsystems 110.

The cache management table 323 is a table that shows the use state of the cache memory 303 in each storage subsystem. Specifically, the cache management table 323 contains, for every address in the cache memory 303, information indicating whether the area that is given the address is in use (i.e., whether data is stored in the area) or not, and, when the area is in use, information indicating which copy pair 601 of which CG 602 uses the area as their cache, and information indicating whether the area serves as their primary cache or secondary cache.

The cache management table 323 is composed of an address 2801, a cache-user CG ID 2802, a cache-user pair ID 2803, and primary/secondary 2804.

The address 2801 indicates the address of an area of the cache memory 303 where data is stored. In this embodiment, data is stored in the cache memory 303 in logical blocks. Accordingly, an address entered as the address 2801 is a logical block address (LBA). The example of FIG. 22B shows “1” to “5” as the address 2801 while omitting the rest. However, every LBA in the cache memory 303 is registered as the address 2801.

The cache-user CG ID 2802, the cache-user pair ID 2803 and the primary/secondary 2804 indicate how an area identified by the address 2801 is being used. For instance, in an entry of the table of FIG. 22B that has “1” as the address 2801, the cache-user CG ID 2802, the cache-user pair ID 2803 and the primary/secondary 2804 are “CG1”, “Pair11” and “secondary”, respectively. This means that the logical block whose LBA in the cache memory 303 is “1” is being used as the secondary cache of Pair11, which belongs to CG1. Similarly, in the example of FIG. 22B, the logical blocks having LBAs “2”, “3” and “5” are being used as the primary cache of Pair12, which belong to CG2. The area whose LBA is “4” is not in use in the example of FIG. 22B. Accordingly, in an entry that has “4” as the address 2801, cells for the cache-user CG ID 2802, the cache-user pair ID 2803 and the primary/secondary 2804 are blank (“−”).

FIG. 22C is an explanatory diagram of the link operation state table 324 stored in a storage subsystem according to the first embodiment of this invention.

The link operation state table 324 is, as shown in FIGS. 3 to 5, stored in the memory 306 of each of the direct-coupled storage subsystem 100, the remote storage subsystems 110 and the remote storage subsystem 120. Shown in FIG. 22C as an example is the link operation state table 324 stored in Casing Two, which is one of the remote storage subsystems 110.

The link operation state table 324 is a table that shows the operation state of the links 160 that connects storage subsystems to one another. Specifically, the link operation state table 324 contains, for each link 160 connected to storage subsystems, information indicating whether the link 160 is in operation or not. One link 160 is deemed as being in operation when data can be transferred normally through this link 160. One link 160 is not in operation when data cannot be transferred through this link 160 because of a failure or the like.

The link operation state table 324 is composed of a link ID 2901, a primary storage subsystem ID 2902, a secondary storage subsystem ID 2903 and operation state information 2904.

The link ID 2901 indicates the identifier of each link 160.

The primary storage subsystem ID 2902 indicates the identifier of a storage subsystem that is connected on the primary side (namely, the side closer to the host computer) of each link 160.

The secondary storage subsystem ID 2903 indicates the identifier of a storage subsystem that is connected on the secondary side (namely, the side farther to the host computer) of each link 160.

The operation state information 2904 indicates whether the link 160 identified by the link ID 2901 is in operation or not. “OK” registered as the operation state information 2904 indicates that the link 160 is in operation whereas “NG” indicates that the link 160 is not in operation.

In the example of FIG. 22C, two links 160 connect Casing One and Casing Two to each other, and have “Link1” and “Link2” as the link ID 2901. These two links are in operation. Casing Two and Casing Three are connected to each other by two links 160 that have “Link3” and “Link3” as the link ID 2901. Link Three is in operation whereas Link Four is not in operation.

For instance, in the case where the rule shown in FIG. 14 and applied in the step 2114 of FIG. 16 is based on the count of links between storage subsystems, the operation state information 2904 of the link operation state table 324 may be consulted in the step 2114.

FIG. 23 is a flow chart of casing information providing processing executed by the casing information management program 313 in a storage subsystem according to the first embodiment of this invention.

In each of the direct-coupled storage subsystem 100, the remote storage subsystems 110 and the remote storage subsystem 120, the casing information management program 313 is stored in the memory 306 as shown in FIGS. 3 to 5 and executed by the processor 304. Casing information providing processing is one of processing executed by the casing information management program 313. In the casing information providing processing, information on a storage subsystem is provided in response to a request from the management computer 140.

The information collecting program 215 of the management computer 140 issues, to each registered monitor subject subsystem, a command requesting information of the storage subsystem in the step 2102 of FIG. 16.

Receiving the command, the casing information management program 313 starts the casing information providing processing. First, the casing information management program 313 obtains, by calculation, the usage (i.e., total cache usage) of the cache memory 303 of the storage subsystem (3001). Specifically, the casing information management program 313 consults the cache management table 323, multiplies the count of addresses that are registered as the address 2801 and are in use by the logical block size, and divides this product by the total capacity of the cache memory 303 to use the resultant value as the total cache usage.

Next, the casing information management program 313 obtains, by calculation, for each CG 602, the usage of the cache memory 303 (the individual cache usage) (3002). Specifically, the casing information management program 313 consults the cache management table 323, sorts the entries by the cache-user CG ID 2802 and the primary/secondary 2804 and, for each group created by the sorting, multiplies the count of addresses that are registered as the address 2801 and are in use by the logical block size. This product is divided by the total capacity of the cache memory 303, and the resultant value is used as the individual cache usage.

To give an example, in the case of the cache management table 323 shown in FIG. 22B, one address (Address 1) is registered as the address 2801 for the secondary cache of CG1. The individual cache usage of the secondary cache of CG1 is therefore a value obtained by dividing the product of “1” and the logical block size by the total capacity of the cache memory 303. To give another example, three addresses (Address 2, Address 3, and Address 5) are registered as the address 2801 for the primary cache of CG2. The individual cache usage of the primary cache of CG2 is therefore a value obtained by dividing the product of “3” and the logical block size by the total capacity of the cache memory 303.

Next, the casing information management program 313 obtains information on the operation state of the link 160 (3003). Specifically, the casing information management program 313 consults the link operation state table 324 to obtain the count of the links 160 that are usable.

Then the casing information management program 313 sends the information obtained in the steps 3001, 3002, and 3003 to the management computer 140 as a response to the request (3004).

I/O delay implemented in the thus configured first embodiment of this invention will be described with reference to FIG. 1.

The description takes as an example the case where the total cache usage of the cache memory 303 exceeds its threshold in Casing Three and the individual cache usage of the secondary cache exceeds its threshold in CG2.

In this case, the cache memory 303 of Casing Three can be prevented from overflowing by implementing I/O delay in a manner that delays writing in LU12 of Casing Three.

However, in some cases, Casing Three cannot implement I/O delay. Despite having the I/O delay processing program 312, I/O delay cannot be implemented unless the cache memory 303 of Casing Two has a large free capacity left. Data in the cache memory 303 of Casing Two cannot be deleted until transfer of the data to Casing Three is completed, and the rate of the transfer from Casing Two to Casing Three is lowered by implementing I/O delay. As a result, the rate at which data is deleted from the cache memory 303 of Casing Two is also lowered, which increases the chance for the cache memory 303 of Casing Two to overflow.

Even when Casing Three has the I/O delay processing program 312 and the cache memory 303 of Casing Two has a large free capacity left, there are still cases where implementing I/O delay does not stop the cache memory 303 from overflowing. For instance, when none of the links 160 between Casing Three and Casing Four are usable, lowering the data transfer rate by implementing I/O delay does not stop the cache memory 303 from overflowing eventually.

Though not shown in FIG. 1, in the case where there is a different sequence of CG 602 than the ones of CG1 and CG2 in Casing Two, an overflow of the cache memory 303 of Casing Two suspends copy pair in the CG 602 in the different sequence. Thus, there are cases where an overflow in one CG 602 affects the CG 602 that is in another sequence.

The management computer 140 judges whether or not the cache memory 303 of Casing Two exceeds a usage threshold as shown in FIGS. 16 and 17. When the usage is lower than the threshold, the cache memory 303 has a large free capacity left and, accordingly, the management computer 140 issues an I/O delay command to delay writing in LU11 to Casing Two. On the other hand, when the usage exceeds the threshold, the cache memory 303 does not have much free capacity left, and therefore the management computer 140 judges whether the cache memory 303 of Casing One exceeds a usage threshold or not. When the cache memory 303 of Casing One is lower than the usage threshold, the management computer 140 issues an I/O delay command to delay writing in LU10 to Casing One. In the case where implementing I/O delay does not stop the cache memory 303 from overflowing, the management computer 140 does not issue an I/O delay command.

As has been described with reference to FIG. 2 and FIG. 6B, the management computer 140 of this embodiment holds, for each storage subsystem, information on whether or not the storage subsystem has the I/O delay processing program 312 (i.e. information on whether or not the storage subsystem can implement I/O delay). The management computer 140 also obtains the use state of the cache memory 303 of each storage subsystem when the usage of the cache memory 303 exceeds its threshold in one of the storage subsystems. Then the management computer 140 orders a storage subsystem in which I/O delay can be implemented and whose cache memory 303 has a large free capacity left to implement I/O delay.

I/O delay, which is implemented in this embodiment by storage subsystems, may instead be implemented by a host computer.

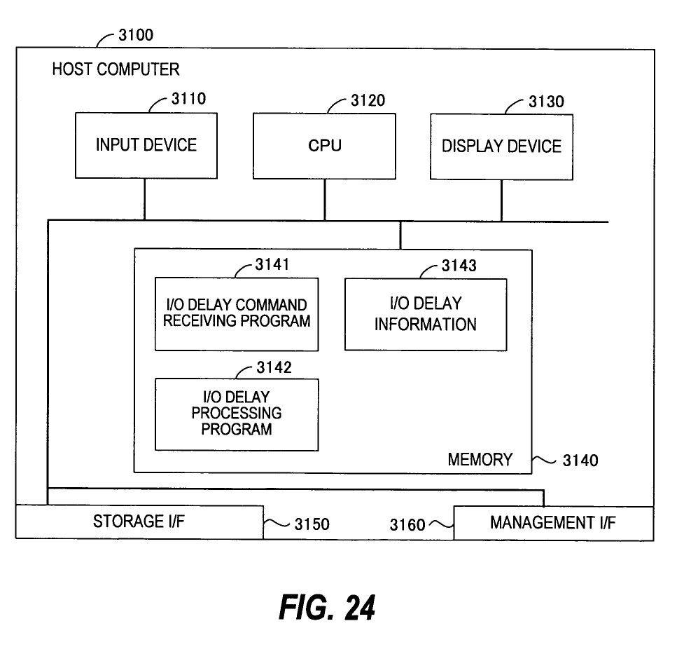

FIG. 24 is a block diagram of a host computer 3100 which implements I/O delay according to the first embodiment of this invention.

The host computer 3100 can replace the host computer 130 in FIG. 1. However, the host computer 3100 is connected to the management network 170 in addition to the storage network 150.

The host computer 3100 has an input device 3110, a CPU 3120, a display device 3130, a memory 3140, a storage I/F 3150, and a management I/F 3160.

The input device 3110 is a device used by a user to control the host computer 3110. For example, a keyboard or a pointing device can serve as the input device 3110.

The CPU 3120 is a processor that executes various programs stored in the memory 3140.

The display device 3130 is a device on which information to be presented to the user is displayed. An image display device such as a CRT can serve as the display device 3130.

The memory 3140 is, for example, a semiconductor memory. The memory 3140 stores various programs executed by the CPU 3120, and diverse information referred to upon execution of the programs. The memory 3140 of this embodiment stores, at least, an I/O delay command receiving program 3141, an I/O delay processing program 3142, and I/O delay information 3143. The memory 3140 also contains various application programs (not shown) executed by the CPU 3120, to be provided to the user.

The storage I/F 3150 is an interface connected to the direct-coupled storage subsystem 100 via the storage network 150 to communicate with the direct-coupled storage subsystem 100.

The management I/F 3160 is an interface connected to the management computer 140 via the management network 170 to communicate with the management computer 140. The management I/F 3160 is equivalent to the management I/F 302 of each storage subsystem.

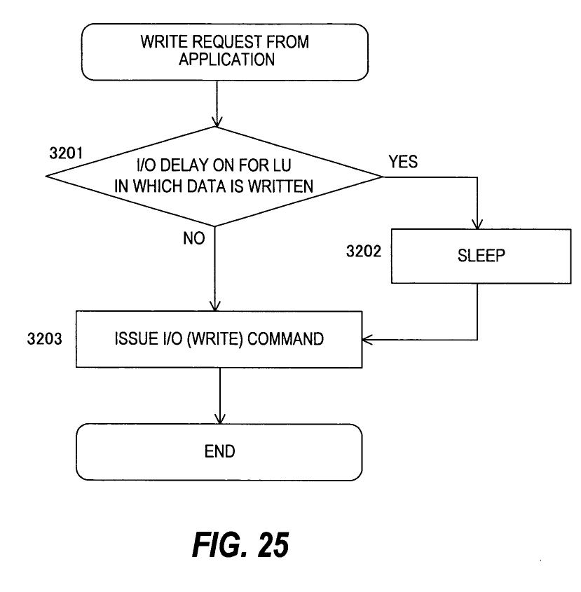

The I/O delay command receiving program 3141 is equivalent to storage subsystem's I/O delay command receiving program 311 shown in FIG. 19. The I/O delay information 3143 holds information similar to the one contained in storage subsystem's I/O delay information 321 shown in FIG. 20. Therefore, descriptions on the I/O delay command receiving program 3141 and the I/O delay information 3143 will be omitted here. The I/O delay processing program 3142 will be described later in detail with reference to FIG. 25.

FIG. 25 is a flow chart of the I/O delay processing program 3142 of the host computer 3100 according to the first embodiment of this invention.

In FIG. 25, details of steps that are similar to those in FIG. 21 will be omitted.

In the host computer 3100, the I/O delay processing program 3142 is stored in the memory 3140 as shown in FIG. 24 and is executed by the processor 3120. The I/O delay processing program 3142 implements I/O delay upon receiving an I/O request to write data from an application program of the host computer 3100.

Reception of write data from the application program starts up the I/O delay processing program 3142, which proceeds to search the I/O delay information 3143 for the LU 331 in which the received data is to be written. The I/O delay processing program 3142 judges whether or not “ON” is registered as the delay 2502 for the LU ID 2501 of the LU 331 in which the received data is to be written (3201).

When it is judged in the step 3201 that “ON” is registered as the delay 2502 for the LU ID 2501 of the LU 331 in which the received data is to be written, the I/O delay processing program 3142 implements I/O delay by entering into a sleep mode and staying in the mode for a given period of time (3202). Thereafter, the I/O delay processing program 3142 executes write processing (3203).

On the other hand, when it is judged in the step 3201 that “ON” is not registered as the delay 2502 for the LU ID 2501 of the LU 331 in which the received data is to be written, I/O delay is not implemented and the I/O delay processing program 3142 immediately executes write processing instead of entering into a sleep mode (3203).

Thus, having the host computer 3100 implement I/O delay instead of storage subsystems is also capable of slowing down the rate of transferring data to a storage subsystem, and can therefore prevent the cache memory 303 from overflowing.

This embodiment described above is also applicable to a case where one CG 602 is formed over plural storage subsystems.

FIG. 26 is an explanatory diagram of consistency groups that stretch over plural storage subsystem sequences and copy pairs formed in a computer system according to the first embodiment of this invention.

As has been described with reference to FIG. 17, one CG 602 is regarded as stretching over plural storage subsystems when this CG 602 is constituted of plural copy pairs 601 and these copy pairs 601 belong to different storage subsystem sequences. Specifically, CG1, CG2, and CG3 in FIG. 26 are the CGs 602 that stretch over plural storage subsystems.

In FIG. 26, the part that is similar to FIG. 1 will not be described in detail.

Casing One, Casing Two, Casing Three, and Casing Four in FIG. 26 are storage subsystems similar to Casing One, Casing Two, Casing Three, and Casing Four of FIG. 1. The difference is that Casing One, Casing Two, Casing Three, and Casing Four of FIG. 26 do not store LU20, LU21, LU22, and LU23, respectively. In other words, Casing One, Casing Two, Casing Three, and Casing Four of FIG. 26 store LU10, LU11, LU12, and LU13, respectively.

Casing Five, Casing Six, Casing Seven, and Casing Eight are storage subsystems similar to Casing One, Casing Two, Casing Three, and Casing Four. Casing Five stores LU20 and LU30. Casing Six stores LU21 and LU31. Casing Seven stores LU22 and LU32. Casing Eight stores LU23 and LU33.

LU10 and LU11 form Pair11. LU11 and LU12 form Pair12. LU12 and LU13 form Pair13.

LU20 and LU21 form Pair21. LU21 and LU22 form Pair22. LU22 and LU23 form Pair23.

LU30 and LU31 form Pair31. LU31 and LU32 form Pair32. LU32 and LU33 form Pair33.

Pair11 and Pair21 form CG1. Pair12 and Pair22 form CG2. Pair13 and Pair23 form CG3.

The LU10 of Casing One and LU20 of Casing Five are used by a host computer A 130. In other words, data is written in LU10 and LU20 from the host computer A 130.

The LU30 of Casing Five is used by a host computer B 130. In other words, data is written in LU30 from the host computer B 130.

This embodiment described above is also applicable to a computer system that has the configuration of FIG. 26.

In the example of FIG. 26, data written in Casing Three is a copy of data written in Casing One from the host computer A 130. When the usage of the cache memory 303 exceeds its threshold in Casing Three and I/O delay is implemented in Casing Two, the data transfer rate is lowered in Pair11. At this point, since Pair11 and Pair21 belong to the same CG 602, namely, CG1, the data transfer rate in Pair21 is also lowered in order to maintain the data consistency. As a result, the chance of overflow increases not only in the cache memory 303 of Casing One but also in the cache memory 303 of Casing Five. In particular, in the case where Casing Six has been I/O-controlled prior to implementing I/O delay in Casing Two, the cache memory 303 of Casing Five is likely to overflow.

When the cache memory 303 of Casing Five overflows, remote copy is suspended not only in Pair21 but also in Pair31. The cache memory 303 exceeding a usage threshold in Casing Three causes suspension of remote copy in Pair31, which normally has no bearing to Casing Three.

In order to avoid such suspension of remote copy, when one CG 602 stretches over plural storage subsystems as in FIG. 26, this embodiment allows every storage subsystem that is upstream of the storage subsystems 110 or others in which the usage of the cache memory 303 exceeds the threshold to implement I/O delay as in the steps 2206 and 2214 of FIG. 17, whichever cache memory 303 exceeds the usage threshold.

Alternatively, when an upstream storage subsystem contains plural CGs 602 and at least one of these CGs 602 stretches over plural storage subsystems as in FIG. 26, the usage of the cache memory 303 may be checked in each of the plural storage subsystems to implement I/O delay while the cache memory 303 has a large free capacity. When to implement I/O delay may be defined as a rule as shown in FIGS. 12 to 14.

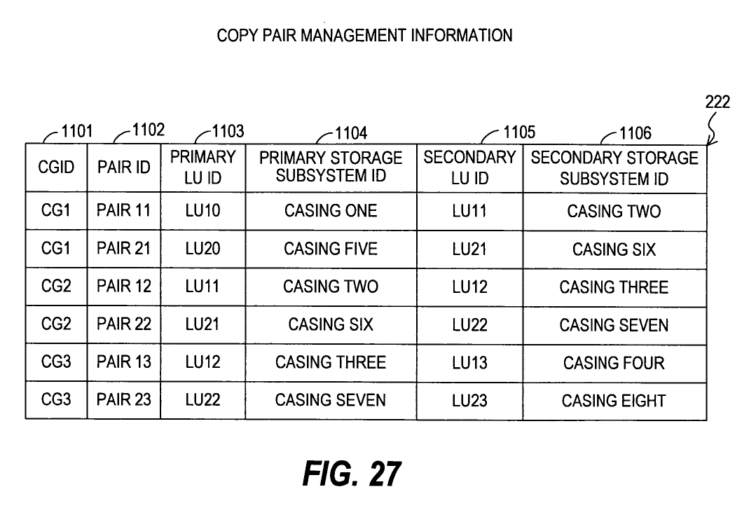

FIG. 27 is an explanatory diagram showing what the copy pair management information 222 stored in the management computer 140 when one consistency group 602 stretches over plural storage subsystem sequences in the first embodiment of this invention.

Pair31, Pair32, and Pair33 are omitted from FIG. 27.

Here, only differences from FIG. 8 will be described.

Pair21 has “Casing Five” as the primary storage subsystem ID 1104 and “Casing Six” as the secondary storage subsystem ID 1106. Pair22 has “Casing Six” as the primary storage subsystem ID 1104 and “Casing Seven” as the secondary storage subsystem ID 1106. Pair23 has “Casing Seven” as the primary storage subsystem ID 1104 and “Casing Eight” as the secondary storage subsystem ID 1106.

According to this embodiment, when the usage of the cache memory 303 exceeds its threshold, I/O delay can be implemented in other storage subsystems than the one to which this cache memory 303 belongs. The management computer 140 selects storage subsystem in which I/O delay is to be implemented in a manner that puts into use the cache memory 303 that has a large free capacity left. As a result, an overflow is avoided in a storage subsystem upstream of the storage subsystem where I/O delay is implemented, and thus I/O delay can be implemented without affecting processing of other CGs.

According to the present invention, the operation state of the links 160 between storage subsystems are observed and, only when an overflow can be avoided by implementing I/O delay, I/O delay is implemented. In other words, this invention does not permit I/O delay that is unavailing, thus avoiding wasting resources and lowering the host I/O performance.

Now, a description is given on a second embodiment of this invention.

The configuration of a computer system according to a second embodiment of this invention will be described first with reference to FIG. 26.

The computer system of this embodiment has eight storage subsystems, host computers 130, and a management computer 140 as does the computer system of the first embodiment shown in FIG. 26.

However, unlike FIG. 26, the management computer 140 of this embodiment is connected to direct-coupled storage subsystems 100, but not to remote storage subsystems 110 and 120. Accordingly, the management computer 140 of this embodiment obtains information from the remote storage subsystems 110 and 120 via the direct-coupled storage subsystems 100. It is also via the direct-coupled storage subsystems 100 that the management computer 140 of this embodiment issues an I/O delay command to the remote storage subsystem 110 and 120. The rest of this embodiment is the same as the first embodiment.

The following description of this embodiment will focus on differences from the first embodiment.

The configuration of the management computer 140 will be described with reference to FIG. 2.

The management computer 140 of this embodiment has the same configuration as the management computer 140 of the first embodiment shown in FIG. 2. However, the contents of monitoring settings information 221 of this embodiment differ from those of the first embodiment. Details of the difference will be described later.

A flow chart of an information collecting program 215 in the management computer 140 of this embodiment is as shown in FIGS. 16 and 17. However, information issued in the steps 2102 and 2116 and to where the information is sent are different from the first embodiment. Details of the difference will be described later.

The configuration of the direct-coupled storage subsystems 100 will be described with reference to FIG. 3.

The direct-coupled storage subsystems 100 of this embodiment have the same configuration as the direct-coupled storage subsystems 100 of the first embodiment shown in FIG. 3. However, an I/O delay command receiving program 311, casing information management program 313, and I/O delay information 321 of this embodiment hold different contents than those in the first embodiment, and there is a self-position-in-sequence determining program 314 added. The I/O delay command receiving program 311, the casing information management program 313, the I/O delay information 321, and the self-position-in-sequence determining program 314 will be described later in detail.

The configuration of the remote storage subsystems 110 will be described with reference to FIG. 4.

The remote storage subsystems 110 of this embodiment have the same configuration as the remote storage subsystems 110 of the first embodiment shown in FIG. 4. However, not connected to the management computer 140, the remote storage subsystems 110 of this embodiment do not need to have the management I/F 302. The I/O delay command receiving program 311, casing information management program 313, and I/O delay information 321 of this embodiment hold different contents than those in the first embodiment, and there is the self-position-in-sequence determining program 314 added.

The configuration of the remote storage subsystems 120 will be described with reference to FIG. 5.

The remote storage subsystems 120 of this embodiment have a configuration obtained by removing the I/O delay command receiving program 311, the I/O delay processing program 312, and the I/O delay information 321 from the remote storage subsystems 110 of the first embodiment.

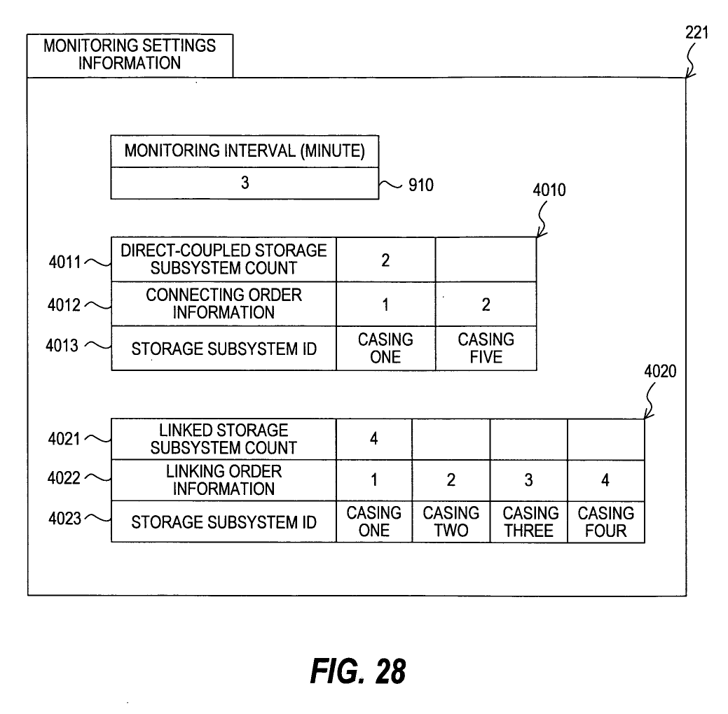

FIG. 28 is an explanatory diagram of the monitoring settings information 221 stored in the management computer 140 according to the second embodiment of this invention.

The monitoring settings information 221 is composed of a monitoring interval 910, direct-coupled storage subsystem information 4010, and linked storage subsystem information 4020.

The monitoring interval 910 is the same as the one contained in the monitoring settings information 221 of the first embodiment shown in FIG. 6.

The direct-coupled storage subsystem information 4010 contains information on the direct-coupled storage subsystems 100 that the computer system has. Specifically, the direct-coupled storage subsystem information 4010 contains a direct-coupled storage subsystem count 4011, connecting order information 4012, and a storage subsystem ID 4013.

The direct-coupled storage subsystem count 4011 indicates the count of the direct-coupled storage subsystems 100 that are in the computer system. The computer system of this embodiment has the configuration shown in FIG. 26, and therefore “2” is entered as the direct-coupled storage subsystem count 4011.

The storage subsystem ID 4013 indicates the identifiers of the direct-coupled storage subsystems 100 that are in the computer system. With the configuration of FIG. 26, “Casing One” and “Casing Five” are entered as the storage subsystem ID 4013.

The connecting order information 4012 indicates an order in which the direct-coupled storage subsystems 100 are connected. In the example of FIG. 28, “1” is registered as the connecting order information 4012 for Casing One whereas “2” is registered as the connecting order information 4012 for Casing Five.

The linked storage subsystem information 4020 contains information on storage system sequences in the computer system. Specifically, the linked storage subsystem information 4020 contains a linked storage subsystem count 4021, linking order information 4022 and a storage subsystem ID 4023.

The linked storage subsystem count 4021 indicates how many storage subsystems constitute one storage subsystem sequence. “4” is entered as the linked storage subsystem count 4021 for a sequence that begins at Casing One and ends at Casing Four of FIG. 26, as well as for a sequence that begins at Casing Five and ends at Casing Eight.

The storage subsystem ID 4023 indicates the identifiers of storage subsystems that constitute each sequence. For the sequence that begins at Casing One and ends at Casing Four of FIG. 26, “Casing One”, “Casing Two”, “Casing Three” and “Casing Four” are entered as the storage subsystem ID 4023. For the sequence that begins at Casing Five and ends at Casing Eight of FIG. 26, “Casing Five”, “Casing Six”, “Casing Seven” and “Casing Eight” are entered as the storage subsystem ID 4023 (not shown).

The linking order information 4022 is order information given to each storage subsystem. “1” is assigned as the linking order information 4022 to the most upstream storage subsystems (the direct-coupled storage subsystems 100), and the value assigned as the linking order information 4022 is incremented by 1 for each next downstream storage subsystem. For example, values assigned as the linking order information 4022 to “Casing One”, “Casing Two”, “Casing Three” and “Casing Four” are “1”, “2”, “3” and “4”, respectively.

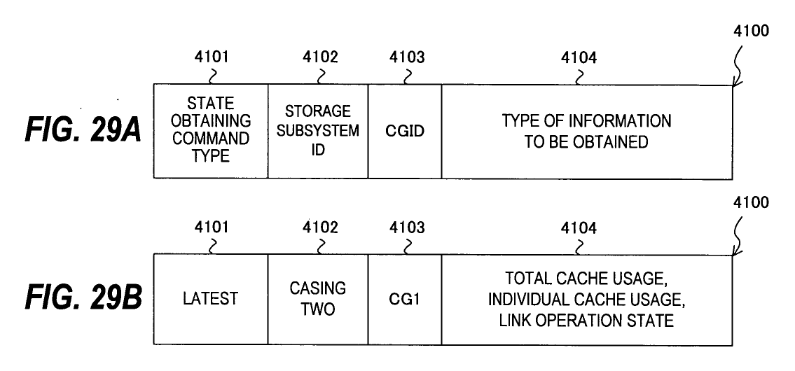

FIGS. 29A and 29B are explanatory diagrams of a state information obtaining command issued to the direct-coupled storage subsystems 100 by the management computer 140 according to the second embodiment of this invention.

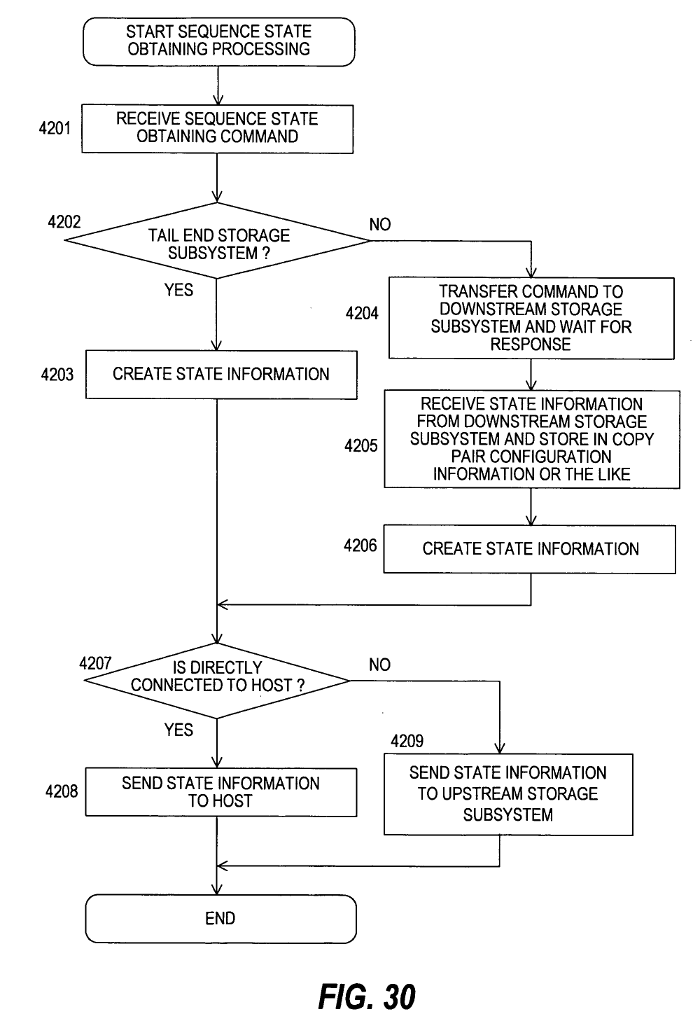

As the management computer 140 obtains information from storage subsystems in the step 2102 of FIG. 16, state information obtaining command data 4100 shown in FIG. 29A is issued from the management computer 140 to the direct-coupled storage subsystems 100. Each storage subsystem transfers the received state information obtaining command data 4100 to its downstream storage subsystem, if there is any, as shown in FIG. 30.

FIG. 29A is a diagram showing the format of the state information obtaining command data 4100, and FIG. 29B is a diagram showing an example of the state information obtaining command data 4100.

The state information obtaining command data 4100 contains, at least, a state obtaining command type 4101, a storage subsystem ID 4102, a CG ID 4103 and a type-of-information-to-be-obtained 4104 as shown in FIG. 29A.

The state obtaining command type 4101 is information indicating the type of a command issued. In the example of FIG. 29B, “latest” is entered as the state obtaining command type 4101 in order to obtain the latest pair state and the like.

The storage subsystem ID 4102 indicates the identifier of a storage subsystem from which the information is to be obtained. In the example of FIG. 29B, “Casing Two” is entered as the storage subsystem ID 4102 to obtain the information from Casing Two.

The CG ID 4103 indicates the identifier of the CG 602 from which the information is to be obtained. In the example of FIG. 29B, “CG1” is entered as the CG ID 4103 to obtain the information from CG1.

The type-of-information-to-be-obtained 4104 is information indicating the type of information to be obtained. In the example of FIG. 29B, the information to be obtained is the total cache usage, the individual cache usage, and the link operation state.

FIG. 30 is a flow chart of sequence state obtaining processing executed by the casing information management program 313 in a storage subsystem according to the second embodiment of this invention.

Starting the sequence state obtaining processing, the casing information management program 313 of a storage subsystem first receives the state information obtaining command data 4100 shown in FIGS. 29A and 29B (4201).

Next, the casing information management program 313 has the self-position-in-sequence determining program 314 judge whether or not the storage subsystem that stores the casing information management program 313 (hereinafter referred to as associated storage subsystem) is a tail end storage subsystem. The term tail end storage system refers to a storage subsystem downstream of which no storage subsystem is connected. In the example of FIG. 26, Casing Four and Casing Eight are tail end storage subsystems.

When it is judged in the step 4202 that the associated storage subsystem is a tail end storage subsystem, state information is created in accordance with the type-of-information-to-be-obtained 4104 of the received state information obtaining command data 4100 (4203). In this embodiment, the casing information management program 313 consults the copy pair configuration information 322, the cache management table 323 and the link operation state table 324 to create state information from the total cache usage, the individual cache usage, and the link operation state.

On the other hand, when it is judged in the step 4202 that the associated storage subsystem is not a tail end storage subsystem, it is necessary to obtain information from a storage subsystem downstream of the associated storage subsystem. The casing information management program 313 therefore transfers the state information obtaining command data 4100 to the downstream storage subsystem, and waits for a response from the downstream storage subsystem (4204).

Receiving a response from the downstream storage subsystem, the casing information management program 313 stores the received state information in the copy pair configuration information 322 and others (4205), and adds state information of the associated storage subsystem to create state information (4206).

Once the state information is created (4203 or 4206), the casing information management program 313 has the self-position-in-sequence determining program 314 judge whether the associated storage subsystem is directly connected to one of the host computers 130 or not (in other words, whether the associated storage subsystem is one of the direct-coupled storage subsystems 100 or not) (4207).

When it is judged in the step 4207 that the associated storage subsystem is directly connected to one of the host computers 130, the casing information management program 313 sends the state information to the one of the host computers 130 that is connected to the associated storage subsystem (4208).

On the other hand, when it is judged in the step 4207 that the associated storage subsystem is not directly connected to any of the host computers 130, the casing information management program 313 sends the state information to a storage subsystem upstream of the associated storage subsystem (4209).

As the above steps are finished, the sequence state obtaining processing is ended.

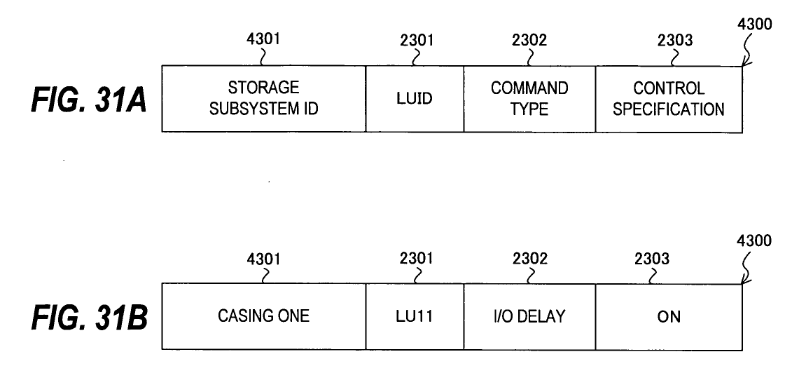

FIGS. 31A and 31B are explanatory diagrams of an I/O delay command issued to a storage subsystem by the management computer 140 according to the second embodiment of this invention.

As the management computer 140 issues an I/O delay command in the step 2116 or 2106 of FIG. 16, I/O delay command data 4300 shown in FIGS. 31A and 31B is transferred from the management computer 140 to the direct-coupled storage subsystem 100. FIG. 31A is a diagram showing the format of the I/O delay command data 4300, and FIG. 31B is a diagram showing an example of the I/O delay command data 4300.

The I/O delay command data 4300 is, as shown in FIG. 31A, the I/O delay command data 2300 of the first embodiment to which a subsystem ID 4301 is added. Descriptions on the LU ID 2301, the command type 2302 and the control specification 2303 have been given with reference to FIGS. 18A and 18B, and therefore will be omitted here.

In this embodiment, unlike the first embodiment, every I/O delay command is transferred from the management computer 140 to the direct-coupled storage subsystem 100. This means that each storage subsystem may receive an I/O delay command that is directed to other storage subsystems. For that reason, the I/O delay command data 4300 contains the subsystem ID 4301 that identifies the storage subsystem that is to be I/O-controlled by an issued I/O delay command. In the example of FIG. 31B, the storage subsystem that is to be I/O-controlled by an issued I/O delay command is Casing One, and “Casing One” is written as the subsystem ID 4301.

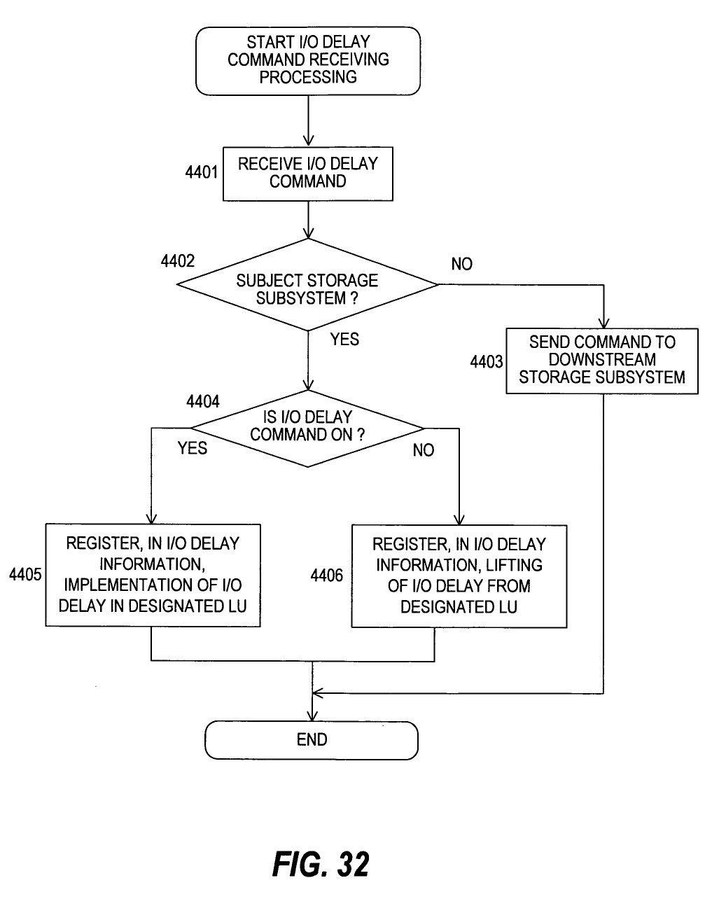

FIG. 32 is a flow chart of the I/O delay command receiving program 311 of a storage subsystem according to the second embodiment of this invention.

In each of the direct-coupled storage subsystem 100 and the remote storage subsystems 110, the I/O delay command receiving program 311 is stored in the memory 306 and is executed by the processor 304. Upon receiving an I/O delay command issued from the management computer 140 in the step 2116 or 2106 of FIG. 16, the I/O delay command receiving program 311 sets implementation or lift of I/O delay.

The I/O delay command receiving program 311 receives an I/O delay command (4401), and judges whether or not the storage subsystem that has received this I/O delay command (hereinafter referred to as recipient storage subsystem) is a storage subsystem that is to be I/O-controlled by this I/O delay command (subject storage subsystem) (4402). Specifically, the I/O delay command receiving program 311 checks the subsystem ID 4301 of the received I/O delay command data 4300 and, when the identifier written as the subsystem ID 4301 matches the identifier of the recipient storage subsystem, judges the recipient storage subsystem as the subject of this I/O delay command.

When it is judged in the step 4402 that the recipient storage subsystem is not the subject of this I/O delay command, it means that this I/O delay command has been issued to another storage subsystem. Accordingly, the I/O delay command receiving program 311 transfers the I/O delay command to a downstream storage subsystem (4403), and ends the processing.

On the other hand, when it is judged in the step 4402 that the recipient storage subsystem is the subject of this I/O delay command, the I/O delay command receiving program 311 judges whether the received I/O delay command is “ON” (i.e., a command to implement I/O delay) or not (4404). Specifically, the I/O delay command receiving program 311 judges whether or not the I/O delay command data 4300 holds “I/O delay” and “ON” as the command type 2302 and the control specification 2303, respectively.

When it is judged in the step 4404 that the received I/O delay command is “ON”, the order is to implement I/O delay. The I/O delay command receiving program 311 therefore registers, in the I/O delay information 313, implementation of I/O delay for the LU ID 2301 designated by the I/O delay command (4405).

On the other hand, when it is judged in the step 4404 that the received I/O delay command is “OFF”, the order is to lift I/O delay. The I/O delay command receiving program 311 therefore registers, in the I/O delay information 313, lift of I/O delay for the LU ID 2301 designated by the I/O delay command (4406).

With the above steps finished, the processing is ended.

According to this embodiment described above, the management computer 140 can issue an I/O delay command via the direct-coupled storage subsystems 100 to remote storage subsystems 110 and 120 which are downstream of the direct-coupled storage subsystems 100. This enables the management computer 140 to control the remote storage subsystems 110 and 120 without being connected directly to the remote storage subsystems 110 and 120.

What is claimed is:

1. A management computer that manages plural storage subsystems in a computer system, the computer system having a host computer that writes data in at least one of the plural storage subsystems,
wherein the plural storage subsystems constitute at least one sequence that is composed of at least three storage subsystems connected in series,
wherein the host computer is connected to the most upstream storage subsystem of the sequence,
wherein the plural storage subsystems each have:
one or more logical volumes where data is stored; and
a buffer where data is stored temporarily,
wherein the logical volume of one of the storage subsystems and the logical volume of another of the storage subsystems form a pair for remote copy,
wherein the buffer stores at least one of data to be stored in the logical volume from the host computer, data to be stored in the logical volume through the remote copy from another storage subsystem, and data to be sent through the remote copy to another storage subsystem, and
wherein the management computer comprises an information collecting module, which observes a usage of the buffer in each of the plural storage subsystems, and which issues, when the usage of the buffer exceeds a given threshold in a first storage subsystem, a delay command to delay executing write processing to a second storage subsystem that is upstream of the first storage subsystem.

2. The management computer according to claim 1, wherein, when the usage of the buffer of the first storage subsystem exceeds the given threshold, the information collecting module issues the delay command to a third storage subsystem, that is upstream of the first storage subsystem and which has an input/output delaying module to delay executing the write processing.

3. The management computer according to claim 1, wherein, when the usage of the buffer of the first storage subsystem exceeds the given threshold, the information collecting module observes the usage of the buffer in the storage subsystems that are upstream of the first storage subsystem, and issues the delay command to a fifth storage subsystem, which is immediately downstream of a fourth storage subsystem, the fourth storage subsystem being one of the storage subsystems that are upstream of the first storage subsystem and having a buffer usage lower than the given threshold.

4. The management computer according to claim 1,
wherein the plural storage subsystems constitute at least two of the sequence,
wherein a consistency group in which a data update order is kept is constituted of more than one of the pair, and
wherein, when the usage of the buffer of the first storage subsystem exceeds the given threshold, and when the pairs in the same consistency group belong to different sequences, the information collecting module issues the delay command to the most upstream storage subsystem.

5. The management computer according to claim 1, further comprising a delay implementation determining module that determines whether delaying the write processing can stop the buffer from overflowing or not,
wherein, when the usage of the buffer of the first storage subsystem exceeds the given threshold, and when the delay implementation determining module determines that delaying the write processing can stop the buffer from overflowing, the information collecting module issues the delay command to the second storage subsystem, which is upstream of the first storage subsystem.

6. The management computer according to claim 5, wherein, when the count of links between the first storage subsystem, where the usage of the buffer has exceeded the given threshold, and when a storage subsystem that is immediately downstream of the first storage subsystem is larger than a given threshold, the delay implementation determining module determines that delaying the write processing can stop the buffer from overflowing.

7. A computer system, comprising:
plural storage subsystems;
a host computer that writes data in at least one of the plural storage subsystems; and
a management computer that manages the plural storage subsystems,
wherein the plural storage subsystems constitute at least one sequence that is composed of at least three storage subsystems connected in series,
wherein the host computer is connected to the most upstream storage subsystem of the sequence,
wherein the plural storage subsystems each have:
one or more logical volumes where data is stored; and
a buffer where data is stored temporarily,
wherein the logical volume of one of the storage subsystems and the logical volume of another of the storage subsystems form a pair for remote copy,
wherein the buffer stores at least one of data to be stored in the logical volume from the host computer, data to be stored in the logical volume through the remote copy from another storage subsystem, and data to be sent through the remote copy to another storage subsystem, and
wherein the management computer comprises an information collecting module, which observes a usage of the buffer in each of the plural storage subsystems, and which issues, when the usage of the buffer exceeds a given threshold in a first storage subsystem, a delay command to delay executing write processing to a second storage subsystem that is upstream of the first storage subsystem.

8. The computer system according to claim 7, wherein, when the usage of the buffer of the first storage subsystem exceeds the given threshold, the information collecting module issues the delay command to a third storage subsystem, that is upstream of the first storage subsystem and which has an input/output delaying module to delay executing the write processing.

9. The computer system according to claim 7, wherein, when the usage of the buffer of the first storage subsystem exceeds the given threshold, the information collecting module observes the usage of the buffer in the storage subsystems that are upstream of the first storage subsystem, and issues the delay command to a fifth storage subsystem, which is immediately downstream of a fourth storage subsystem, the fourth storage subsystem being one of the storage subsystems that are upstream of the first storage subsystem and having a buffer usage lower than the given threshold.

10. The computer system according to claim 7,
wherein the plural storage subsystems constitute at least two of the sequence,
wherein a consistency group in which a data update order is kept is constituted of more than one of the pair, and
wherein, when the usage of the buffer of the first storage subsystem exceeds the given threshold, and when the pairs in the same consistency group belong to different sequences, the information collecting module issues the delay command to the most upstream storage subsystem.

11. The computer system according to claim 7, further comprising a delay implementation determining module that determines whether delaying the write processing can stop the buffer from overflowing or not,
wherein, when the usage of the buffer of the first storage subsystem exceeds the given threshold, and when the delay implementation determining module determines that delaying the write processing can stop the buffer from overflowing, the information collecting module issues the delay command to the second storage subsystem, which is upstream of the first storage subsystem.

12. The computer system according to claim 11, wherein, when the count of links between the first storage subsystem, where the usage of the buffer has exceeded the given threshold, and when a storage subsystem that is immediately downstream of the first storage subsystem is larger than a given threshold, the delay implementation determining module determines that delaying the write processing can stop the buffer from overflowing.

13. The computer system according to claim 7,
wherein the information collecting module obtains, via the storage subsystem that is connected to the host computer, the usage of the buffer in each of the plural storage subsystems, and
wherein, when the usage of the buffer of the first storage subsystem exceeds the given threshold, the information collecting module issues, via the storage subsystem that is connected to the host computer, the delay command to the storage subsystem that is upstream of the first storage subsystem.

14. A management method for a computer system having a host computer that writes data in at least one of the plural storage subsystems,
wherein the plural storage subsystems constitute at least one sequence that is composed of at least three storage subsystems connected in series,
wherein the host computer is connected to the most upstream storage subsystem of the sequence,
wherein the plural storage subsystems each have:
one or more logical volumes where data is stored; and
a buffer where data is stored temporarily,
wherein the logical volume of one of the storage subsystems and the logical volume of another of the storage subsystems form a pair for remote copy,
wherein the buffer stores at least one of data to be stored in the logical volume from the host computer, data to be stored in the logical volume through the remote copy from another storage subsystem, and data to be sent through the remote copy to another storage subsystem, and
wherein the management method comprises:
observing a usage of the buffer in each of the plural storage subsystems; and
issuing, when the usage of the buffer exceeds a given threshold in a first storage subsystem, a delay command to delay executing write processing to a second storage subsystem that is upstream of the first storage subsystem.

15. The management method according to claim 14, wherein the issuing of a delay command includes issuing the delay command to a third storage subsystem, that is upstream of the first storage subsystem and which has an input/output delaying module to delay executing the write processing.

16. The management method according to claim 14, wherein, when the usage of the buffer of the first storage subsystem exceeds the given threshold, the issuing of a delay command includes observing the usage of the buffer in the storage subsystems that are upstream of the first storage subsystem, and issues the delay command to a fifth storage subsystem, which is immediately downstream of a fourth storage subsystem, the fourth storage subsystem being one of the storage subsystems that are upstream of the first storage subsystem and having a buffer usage lower than the given threshold.

17. The management method according to claim 14,
wherein the plural storage subsystems constitute at least two of the sequence,
wherein a consistency group in which a data update order is kept is constituted of more than one of the pair, and
wherein, when the usage of the buffer of the first storage subsystem exceeds the given threshold, and when the pairs in the same consistency group belong to different sequences, the issuing of a delay command includes issuing the delay command to the most upstream storage subsystem.

18. The management method according to claim 14, wherein the issuing of a delay command includes:
determining whether delaying the write processing can stop the buffer from overflowing or not; and
issuing, when the usage of the buffer of the first storage subsystem exceeds the given threshold, and when it is determined that delaying the write processing can stop the buffer from overflowing, the delay command to the second storage subsystem, which is upstream of the first storage subsystem.

19. The management method according to claim 18, wherein the determining includes determining, when the count of links between the first storage subsystem, where the usage of the buffer has exceeded the given threshold, and when a storage subsystem that is immediately downstream of the first storage subsystem is larger than a given threshold, that delaying the write processing can stop the buffer from overflowing.
